(19) United States
(12) Patent Application Publication
(10) Pub. No.: US 2005/0164115 A1
(43) Pub. Date: Jul. 28, 2005

(54) Process for producing toner

(75) Inventors: Osamu Tamura, Kashiwa-shi (JP); Takeshi Naka, Susono-shi (JP); Yutaka Ishida, Newport News, VA (US)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/968,094

(22) Filed: Oct. 20, 2004

(30) Foreign Application Priority Data
Oct. 20, 2003 (JP) 2003-359876(PAT.)
Oct. 18, 2004 (JP) 2004-303034(PAT.)

(51) Int. Cl. G03G 9/08; G03G 9/00; G03G 5/00

(52) U.S. Cl. 430/110.4; 430/137.2

(57) ABSTRACT

A process for producing a toner with which toner particles can be highly conglobated, a toner that hardly causes fogging in an image, and an yield of toner is increased is provided.

A process for producing a toner of the present invention comprises the step of simultaneously performing a surface modification and classification of particles by using a batch-wise surface modification apparatus, in which when a straight line extending from a central position S1 of a loading pipe in a direction of loading a raw material is denoted by L1 and a straight line extending from a central position O1 of the fine powder discharging pipe in a direction of discharging fine powder and ultra-fine powder is denoted by L2, an angle θ formed between the lines L1 and L2 is in a range of 210 to 330° with reference to the direction in which a classification rotor rotates.

### BACKGROUND OF THE INVENTION

1. Field of the Invention

The present invention relates to a process for producing a toner for use in an image forming method such as an electrophotographic method, an electrostatic recording method, or an electrostatic printing method. 2. Description of the Related Art

In general, processes for producing toner particles are classified into a process using a pulverization method and a process using a polymerization method. At present, toner particles produced according to the pulverization method have an advantage in that the production cost is low as compared to that of the polymerization method, and have been currently used for a toner to be used in a wide variety of copying machines and printers. The production of toner particles according to the pulverization method involves: mixing predetermined amounts of a binder resin, a colorant, and the like; melting and kneading the mixture; cooling the kneaded product to solidify the kneaded product; pulverizing the solidified kneaded product; and classifying the pulverized product to obtain toner particles having a predetermined particle diameter distribution. Then, a flowability improver is externally added to the resultant toner particles to obtain a toner.

In recent years, high image quality, energy conservation, compatibility with the environment, and the like have been demanded for copying machines and printers. In view of those demands, a technical concept of a toner has been shifting in the direction of conglobating toner particles in order to achieve high transfer efficiency and to reduce the amount of waste toner. To achieve such a technical concept according to the pulverization method, JP 09-085741 A proposes a method for conglobating toner particles according to a mechanical pulverization method. In addition, JP 2000-029241 A proposes a method for conglobating toner particles by means of hot air. However, sufficient conglobation cannot be achieved with the method for conglobating toner particles according to a mechanical pulverization method. Moreover, in the method for conglobating toner particles by means of hot air, when the toner particles contain wax, it becomes difficult to control the surface properties of the toner particles if the wax starts to melt. Thus, there remains a problem in terms of quality stability of the toner particles. In view of the above, JP 2002-233787 A proposes a surface modification apparatus for modifying the surface of toner particles, the surface modification apparatus being capable of performing a high-performance surface treatment and removing fine powder. However, the surface modification apparatus tends to have low fine powder removal efficiency (so-called classification yield) and to cause an image fogging phenomenon when a high degree of sphericity is maintained. Therefore, further improvement has been demanded.

### SUMMARY OF THE INVENTION

An object of the present invention is to provide a process for producing a toner which has overcome the above problems.

That is, an object of the present invention is to provide a process for producing a toner with which toner particles can be highly conglobated and an yield of toner particles is increased.

Another object of the present invention is to provide a process for producing a toner with which a toner that hardly causes fogging in an image can be efficiently produced.

The objects of the present invention can be achieved by providing a process for producing a toner containing toner particles, comprising:
a) a kneading step of melting and kneading a composition containing at least a binder resin, a wax, and a colorant to obtain a kneaded product;
b) a cooling step of cooling the kneaded product to obtain a cooled and solidified product;
c) a pulverizing step of finely pulverizing the cooled and solidified product to obtain a finely pulverized product; and
d) a step of simultaneously performing a surface modification step for subjecting particles in the finely pulverized product to surface modification and a classification step for removing fine powder and ultra-fine powder in the resultant finely pulverized product to obtain toner particles, in which:
the step of simultaneously performing the surface modification step and the classification step to obtain toner particles is performed by using a batch-wise surface modification apparatus;

the surface modification apparatus comprises:
i) a cylindrical casing main body;
ii) a loading portion having a loading pipe for loading the finely pulverized product into the casing main body;
iii) classification means having a classification rotor that rotates in a predetermined direction to continuously remove fine powder and ultra-fine powder each having a predetermined particle diameter or smaller from the finely pulverized product loaded into the casing main body to an outside of the apparatus;
iv) a fine powder discharging portion having a fine powder discharging pipe for discharging the fine powder and the ultra-fine powder removed by the classification means to an outside of the casing main body;
v) surface modification means having a dispersion rotor, which rotates in the same direction as the direction in which the classification rotor rotates, for subjecting particles in the finely pulverized product from which the fine powder and the ultra-fine powder are removed to a surface modification treatment by using a mechanical impact force;
vi) cylindrical guide means for forming a first space and a second space in the casing main body; and
vii) a toner particle discharging portion for discharging toner particles which are subjected to the surface modification treatment by the dispersion rotor to the outside of the casing main body;
the first space is formed between an inner side wall of the casing main body and an outer side wall of the cylindrical guide means and comprises a space for introducing the finely pulverized product and surface-modified particles into the classification rotor;
the second space is formed inside the cylindrical guide means and comprises a space for treating the finely pulverized product from which the fine powder and the ultra-fine powder are removed and the surface-modified particles with the dispersion rotor;
in the surface modification apparatus, the finely pulverized product loaded into the casing main body from the loading portion is introduced into the first space, the fine powder and the ultra-fine powder each having a predetermined particle diameter or smaller are removed and continuously discharged to the outside of the apparatus by the classification means while the finely pulverized product from which the fine powder and the ultra-fine powder are removed is moved to the second space and treated with the dispersion rotor to subject the particles in the finely pulverized product to a surface modification treatment, and the finely pulverized product containing the surface-modified particles is circulated in the first space and the second space again, whereby the classification and the surface modification treatment are repeated to obtain surface-modified toner particles in which an amount of each of fine powder and ultra-fine powder each having a predetermined particle diameter or smaller is reduced to a predetermined amount or less;
the loading portion is formed on a side wall of the casing main body and the fine powder discharging portion is formed on a top face of the casing main body; and
when, in a top projection drawing of the surface modification apparatus, a straight line extending from a central position S1 of the loading pipe of the loading portion in a direction of loading the finely pulverized product into the first space is denoted by L1 and a straight line extending from a central position O1 of the fine powder discharging pipe of the fine powder discharging portion in a direction of discharging fine powder and ultra-fine powder is denoted by L2, an angle θ formed between the straight line L1 and the straight line L2 is in a range of 210 to 330° with reference to the direction in which the classification rotor rotates.

### BRIEF DESCRIPTION OF THE DRAWINGS

Other objects and advantages of the present invention will become apparent during the following discussion conjunction with the accompanying drawings, in which:

FIG. 1 shows a schematic cross-sectional drawing of an example of a surface modification apparatus suitably used for a step for obtaining surface-modified toner particles having a suitable particle diameter distribution by subjecting a finely pulverized product to classification and a surface modification treatment in a process for producing a toner of the present invention;

FIG. 2(A) shows an example of a top projection drawing (horizontal projection drawing) of the surface modification apparatus shown in FIG. 1 and FIG. 2(B) shows another example;

FIG. 3 shows a partial schematic perspective drawing of the surface modification apparatus shown in FIG. 1;

FIG. 4(A) is a drawing for explaining an example of a position of a fine powder discharging pipe with respect to a fine powder discharging casing of the surface modification apparatus shown in FIG. 1 and FIG. 4(B) is a drawing for explaining another example of a position of the fine powder discharging pipe with respect to the fine powder discharging casing of the surface modification apparatus shown in FIG. 1;

FIG. 5(A) shows a schematic horizontal projection drawing of a classification rotor and FIG. 5(B) shows a schematic cross-sectional drawing of the classification rotor;

FIG. 6(A) shows a horizontal projection drawing of a dispersion rotor and FIG. 6(B) shows a schematic vertical projection drawing of the dispersion rotor;

FIG. 7(A) shows a drawing for explaining a diameter of a guide ring and FIG. 7(B) shows a perspective drawing of the guide ring and a guide ring support;

FIG. 8(A) shows a schematic horizontal projection drawing of a square disk and FIG. 8(B) shows a schematic vertical projection drawing of the square disk;

FIG. 9(A) shows a schematic horizontal projection drawing of a liner and FIG. 9(B) shows a partial explanatory drawing of the liner;

FIG. 10 shows a partial flow drawing for explaining the process for producing a toner of the present invention;

FIG. 11(A) shows a drawing for explaining a clearance between the guide ring and the square disk and FIG. 11(B) shows a drawing for explaining a clearance between the square disk and the liner;

FIG. 12 shows a drawing for explaining an example of a flow for producing a finely pulverized product; and

FIG. 13 shows a drawing for explaining a positional relationship between a loading pipe and a casing main body.

### DETAILED DESCRIPTION OF THE PREFERRED EMBODIMENTS

The inventors of the present invention have made extensive studies to find that a specific particle diameter distribution of a finely pulverized product is achieved by using a surface modification apparatus that simultaneously performs classification and a surface modification treatment, thereby achieving a process for producing a toner with which an yield of toner particles is increased and a toner capable forming a good image can be produced.

The surface modification apparatus to be used in the production process of the present invention will be described.

The surface modification apparatus used in the present invention is a batch-wise surface modification apparatus that simultaneously performs a step of classifying and removing fine powder and ultra-fine powder in a finely pulverized product and a step of subjecting particles in the finely pulverized product to a surface modification treatment.

The surface modification apparatus used in the present invention includes:
i) a cylindrical casing main body;
ii) a loading portion having a loading pipe for loading the finely pulverized product into the casing main body;
iii) classification means having a classification rotor that rotates in a predetermined direction to continuously remove fine powder and ultra-fine powder each having a predetermined particle diameter or smaller from the finely pulverized product loaded into the casing main body to an outside of the apparatus;
iv) a fine powder discharging portion having a fine powder discharging pipe for discharging the fine powder and the ultra-fine powder removed by the classification means to an outside of the casing main body;
v) surface modification means having a dispersion rotor, which rotates in the same direction as the direction in which the classification rotor rotates, for subjecting particles in the finely pulverized product from which the fine powder and the ultra-fine powder are removed to a surface modification treatment by using a mechanical impact force;
vi) cylindrical guide means for forming a first space and a second space in the casing main body; and
vii) a toner particle discharging portion for discharging toner particles which are subjected to the surface modification treatment by the dispersion rotor to the outside of the casing main body;
the first space is formed between an inner side wall of the casing main body and an outer surface of the cylindrical guide means and comprises a space for introducing the finely pulverized product and surface-modified particles into the classification rotor;
the second space is formed inside the cylindrical guide means and comprises a space for treating the finely pulverized product from which the fine powder and the ultra-fine powder are removed and the surface-modified particles with the dispersion rotor;
in the surface modification apparatus, the finely pulverized product loaded into the casing main body from the loading portion is introduced into the first space, the fine powder and the ultra-fine powder each having a predetermined particle diameter or smaller are removed and continuously discharged to the outside of the apparatus by the classification means while the finely pulverized product from which the fine powder and the ultra-fine powder are removed is moved to the second space and treated with the dispersion rotor to subject the particles in the finely pulverized product to a surface modification treatment, and the finely pulverized product containing the surface-modified particles is circulated in the first space and the second space again, whereby the classification and the surface modification treatment are repeated to obtain surface-modified toner particles in which an amount of each of fine powder and ultra-fine powder each having a predetermined particle diameter or smaller is reduced to a predetermined amount or less.

The loading portion is formed on a side wall of the casing main body and the fine powder discharging portion is formed on a top face of the casing main body, and when, in a top projection drawing of the surface modification apparatus, a straight line extending from a central position S1 of the loading pipe of the loading portion in a direction of loading the finely pulverized product into the first space is denoted by L1 and a straight line extending from a central position O1 of the fine powder discharging pipe of the fine powder discharging portion in a direction of discharging fine powder and ultra-fine powder is denoted by L2, an angle θ formed between the straight line L1 and the straight line L2 is in a range of 210 to 330° with reference to the direction in which the classification rotor rotates.

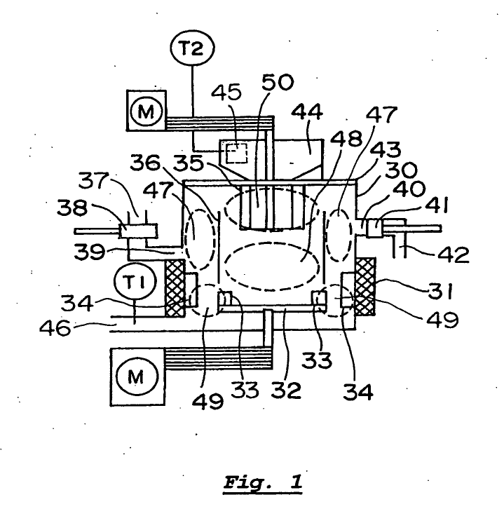

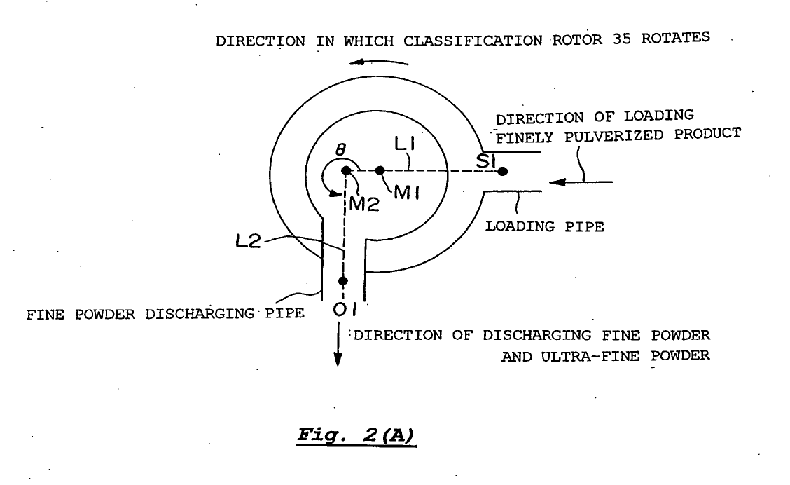

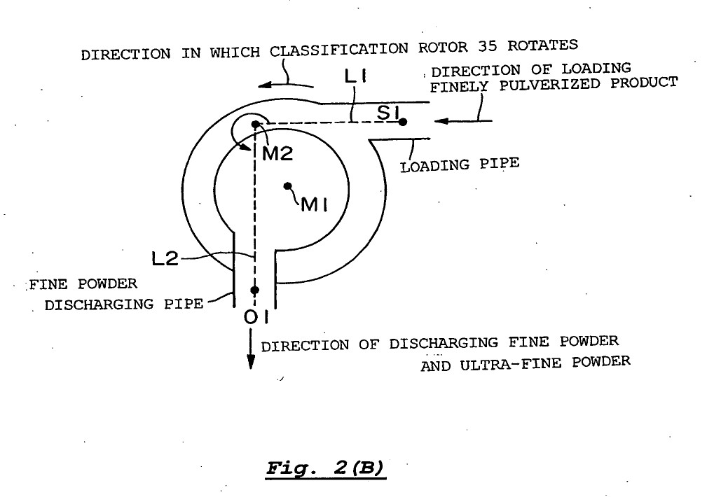

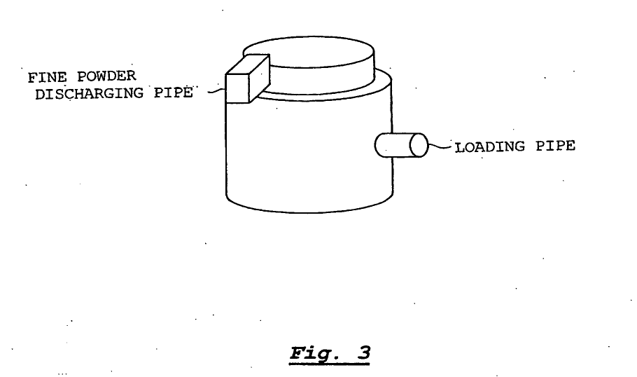

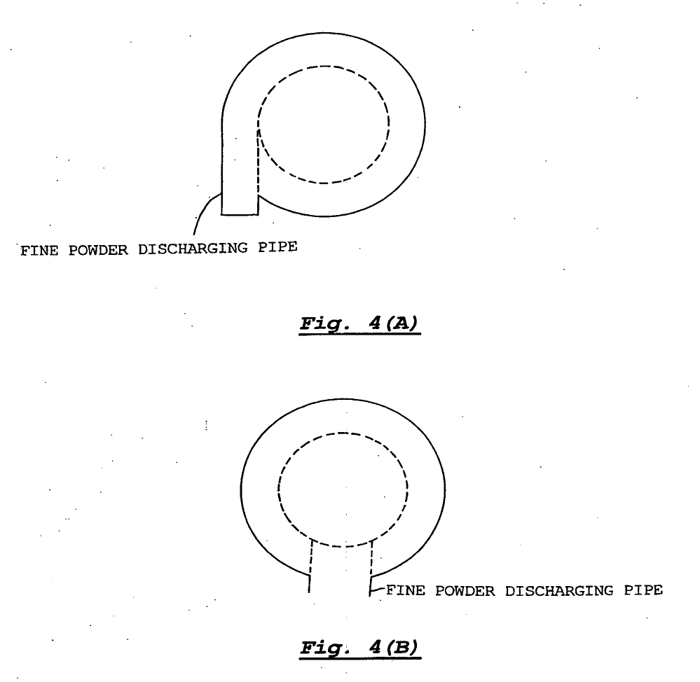

FIG. 1 is a schematic cross-sectional drawing showing a preferable example of a surface modification apparatus to be used in the present invention. In addition, FIG. 2(A) and FIG. 2(B) are top projection drawings (horizontal projection drawings) of the surface modification apparatus shown in FIG. 1, for explaining an angle θ between a loading pipe of the loading portion and a fine powder discharging pipe of the fine powder discharging portion. FIG. 3 shows a schematic perspective drawing for explaining the positional relationship between the loading pipe of the loading portion and the fine powder discharging pipe of the fine powder discharging portion in the surface modification apparatus. FIGS. 4(A) and 4(B) are drawings for explaining the positional relationship between a fine powder discharging casing and the fine powder discharging pipe.

The batch-wise surface modification apparatus shown in FIG. 1 includes: a cylindrical casing main body 30; a top panel 43 placed on an upper portion of the casing main body so as to be openable/closable; a fine powder discharging portion 44 having a fine powder discharging casing and a fine powder discharging pipe; a cooling jacket 31 through which cooling water or antifreeze can pass; a dispersion rotor 32 as surface modification means placed in the casing main body 30 and attached to a central rotation axis, the dispersion rotor 32 having multiple square disks 33 on its top face and the dispersion rotor 32 being a disk-like body of rotation rotating in a predetermined direction at a high speed; a liner 34 fixed and arranged around the dispersion rotor 32 while maintaining a predetermined gap, the liner 34 being provided with a large number of grooves on a surface opposite to the dispersion rotor 32; a classification rotor 35 for continuously removing fine powder and ultra-fine powder each having a predetermined particle diameter or smaller in a finely pulverized product; a cold air introducing port 46 for introducing cold air into the casing main body 30; a loading pipe which is formed on a side wall of the casing main body 30 to introduce the finely pulverized product (raw material), and has a raw material loading port 37 and a raw material supply port 39; a product discharging pipe having a product discharging port 40 for discharging toner particles after a surface modification treatment to the outside of the casing main body 30 and a product ejecting port 42; an openable/closable raw material supply valve 38 placed between the raw material loading port 37 and the raw material supply port 39 so that the surface modification time can be freely adjusted; and a product discharging valve placed between the product discharging port 40 and the product ejecting port 42.

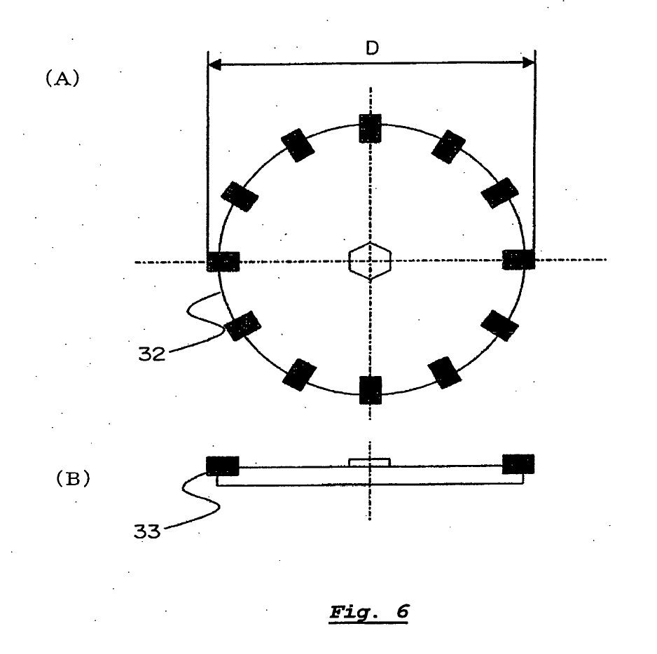

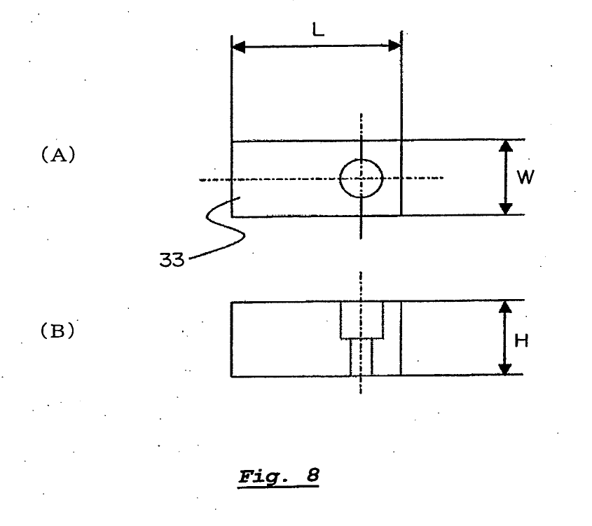

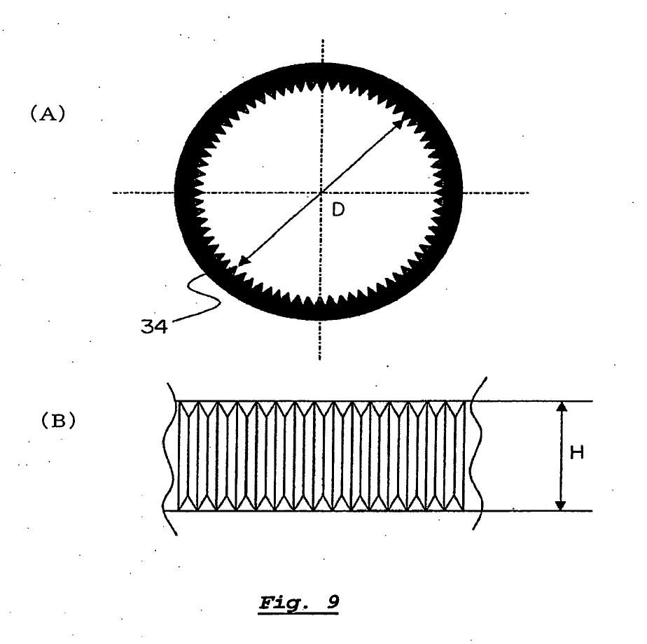

The surface of the liner 34 preferably has grooves as shown in FIGS. 9(A) and 9(B) in order to efficiently perform the surface modification of the toner particles. The number of the square disks 33 is preferably an even number as shown in FIGS. 6(A) and 6(B) in view of balance of rotation. FIGS. 8(A) and 8(B) are explanatory drawings of the square disks 33. As shown in FIGS. 2(A) and 2(B), the direction in which the dispersion rotor 32 rotates is usually a counterclockwise direction when viewed from the top face of the apparatus.

The classification rotor 35 shown in FIGS. 1, 5, and 10 preferably rotates in the same direction as the direction in which the dispersion rotor 32 rotates in order to increase classification efficiency and efficiency of surface modification of toner particles.

The fine powder discharging pipe has a fine powder discharging port 45 for discharging the fine powder and ultra-fine powder removed by the classification rotor 35 to the outside of the apparatus.

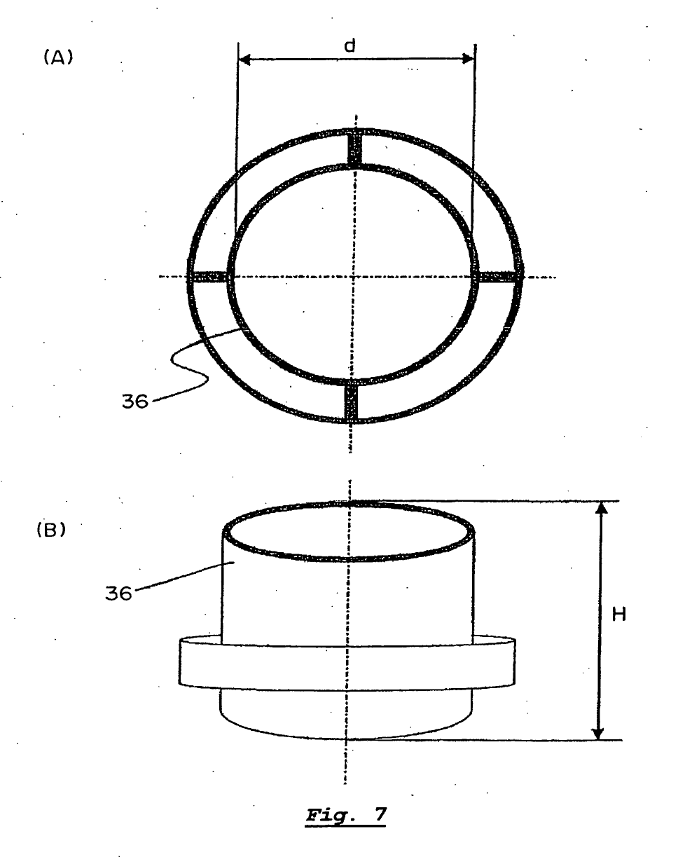

As shown in FIGS. 7(A) and 7(B), the surface modification apparatus further has a cylindrical guide ring 36 in the casing main body 30, the cylindrical guide ring 36 serving as guide means having an axis perpendicular to the top panel 43. The guide ring 36 is arranged so that the top end of the ring is distant from the top panel by a predetermined distance. In addition, the guide ring 36 is fixed to the casing main body 30 by a support in such a manner that at least part of the classification rotor 36 is covered with the guide ring 36. The bottom end of the guide ring 36 is distant from each of the square disks 33 on the dispersion rotor 32 by a predetermined distance. In the surface modification apparatus, the guide ring 36 divides a space between the classification rotor 35 and the dispersion rotor 32 into a first space 47 outside the guide ring 36 and a second space 48 inside the guide ring 36. The first space 47 is a space for introducing a finely pulverized product and surface-modified particles into the classification rotor 35 whereas the second space 48 is a space for introducing the finely pulverized product and the surface-modified particles into the dispersion rotor. A gap between the multiple square disks 33 placed on the dispersion rotor 32 and the liner 34 is a surface modification zone 49 whereas the space where classification rotor 35 is placed and a peripheral portion of the classification rotor 35 is a classification zone 50.

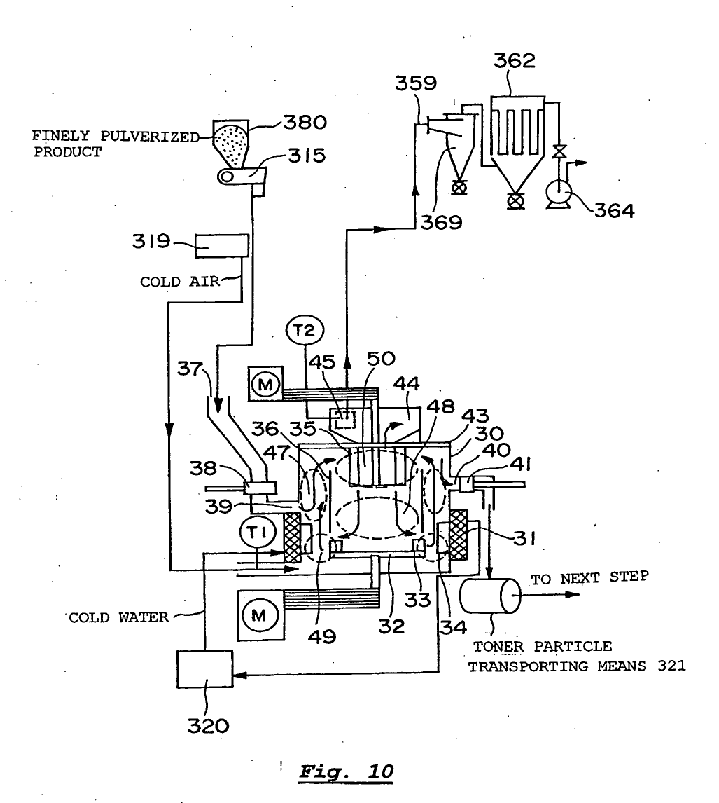

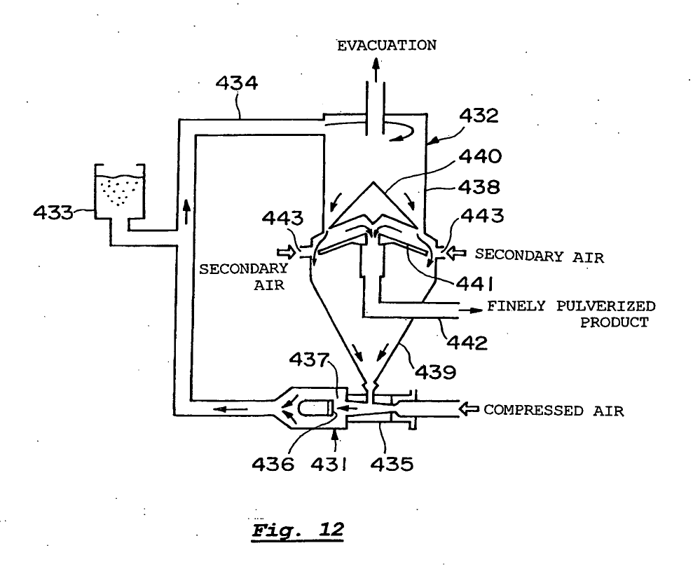

The finely pulverized product to be introduced into the surface modification apparatus can be prepared by introducing a coarsely pulverized product obtained by coarsely pulverizing a melt-kneaded product that has been solidified by cooling into, for example, a fine pulverization system shown in FIG. 12. In the fine pulverization system, the coarsely pulverized product is introduced into a raw material supplier 433 and then introduced into an air classifier 432 from the raw material supplier 433 via a transporting pipe 434. The air classifier 432 has a center core 440 and a separate core 441 in a collector 438. In the air classifier 432, the coarsely pulverized product is classified into a finely pulverized product and a coarse particle by secondary air introduced from a secondary air supply port 443. The classified finely pulverized product is discharged to the outside of the system via a discharging pipe 442 and then introduced into a raw material hopper 380 shown in FIG. 10. The classified coarse particle is introduced into a pulverizer (for example, jet mill) 431 via a hopper main body 439.. In the pulverizer, the coarse particle is supplied to a nozzle 435 into which compressed air is introduced, and then the coarse particle is transported by high-speed compressed air to collide with a collision plate 436 of a pulverization chamber 437 for fine pulverization. A finely pulverized product of the coarse particle is introduced into the air classifier 432 via the transporting pipe 434, followed by classification again.

The finely pulverized product preferably has a weight average particle diameter in the range of 3.5 to 9.0 μm and a ratio of particles each having a particle diameter of 4.00 μm or less in the range of 50 to 80% by number in order to efficiently perform the classification step and the step of treating the particle surface at the same time in the surface modification apparatus in the subsequent step.

As shown in FIG. 10, the finely pulverized product introduced into the raw material hopper 380 passes through the raw material supply valve 38 from the raw material loading port 37 of the loading pipe via a metering supplier 315, and is then supplied to the inside of the apparatus from the raw material supply port 39. In the surface modification apparatus, cold air generated by cold air generating means 319 is introduced into the casing main body from a cold air introducing port 46, and cold water generated by cold water generating means 320 is supplied to the cooling jacket 31 to adjust the temperature inside the casing main body to a predetermined temperature. The supplied finely pulverized product reaches the classification zone 50 near the classification rotor 35 to undergo a classification treatment while being allowed to turn in the first space 47 outside the cylindrical guide ring 36 by a spiral air flow formed by the intake air of a blower 364, the rotation of the dispersion rotor 32, and the rotation of the classification rotor 35. The direction of the spiral air flow formed inside the casing main body 30 is a counterclockwise direction when view from the top face of the apparatus because the direction is the same as the direction in which the dispersion rotor 32 or the classification rotor 35 rotates. See FIG. 2.

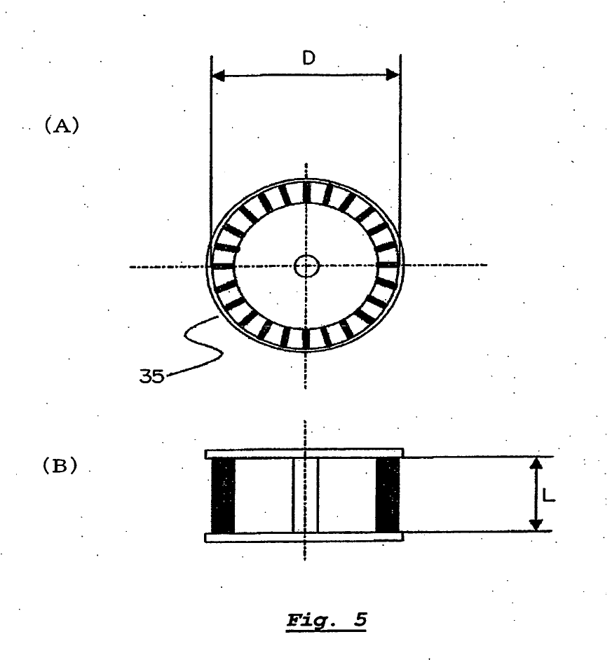

Fine powder and ultra-fine powder to be removed by the classification rotor 35 are sucked from a slit (see FIG. 5) of the classification rotor 35 by virtue of a suction force of the blower 364. Then, the fine powder and the ultra-fine powder are collected in a cyclone 369 and a bag 362 via the fine powder discharging port 45 of the fine powder discharging pipe and a cyclone inlet 359. The finely pulverized product from which the fine powder and the ultra-fine powder are removed reaches the surface modification zone 49 near the dispersion rotor 32 via the second space 48 to undergo a particle surface modification treatment by means of the square disks 33 (hammers) on the dispersion rotor 32 and the liner 34 of the casing main body 30. The particles subjected to surface modification reach a position near the classification rotor 35 again while turning along the guide ring 36. Then, the classification rotor 35 removes fine powder and ultra-fine powder from the surface-modified particles through classification. After a predetermined time of treatment, a discharging valve 41 is opened to take out of the surface modification apparatus surface-modified toner particles from which fine powder and ultra-fine powder each having a predetermined particle diameter or smaller are removed.

The toner particles subjected to surface modification to have a predetermined weight average particle diameter, a predetermined particle diameter distribution, and a predetermined circularity are transported to a step of externally adding an external additive by toner particle transporting means 321.

The inventors of the present invention have made studies to find that a relationship between the position of the loading pipe of the finely pulverized product (raw material) and the position of the fine powder discharging pipe has influences on an increase in yield of toner particles and on alleviation of a fogging phenomenon of toner. Those influences appear when a relationship between a central position of the raw material supply port 39 of the loading pipe and a central position of the fine powder discharging port 45 of the fine powder discharging pipe satisfies the following relationship. When, in the top projection drawings shown in FIGS. 2(A) and 2(B) when viewed from the top face of the surface modification apparatus, a straight line extending from a central position S1 of the loading pipe (raw material supply port 39) in a loading direction is denoted by L1 and a straight line extending from a central position O1 of the fine powder discharging portion in a discharging direction is denoted by L2, an angle e formed between the straight line L1 and the straight line L2 at the intersection M2 is in the range of 210° to 330° with reference to the direction in which the classification rotor 35 rotates. In FIGS. 2(A) and 2(B), M1 denotes a central position of the fine powder discharging casing 44. As shown in FIG. 2(B), the loading pipe of the finely pulverized product is preferably arranged in a tangential direction with respect to the casing main body 30 to introduce the finely pulverized product in the tangential direction of the outer surface of the cylindrical guide ring 36. This is because the classification efficiency of the finely pulverized product is increased with such an arrangement.

As shown in FIGS. 2(A) and 2(B), the central position S1 of the loading portion indicates the middle point of the diameter (or width) of the loading pipe whereas the central position O1 of the fine powder discharging portion indicates the middle point of the diameter (or width) of the fine powder discharging pipe. The angle θ is an angle formed between a straight line S1-M2 and a straight line O1-M2 where M2 denotes an intersection point of the straight line L1 passing through the central position S1 and extending in parallel with the raw material loading direction and the straight line L2 passing through the central position O1 and extending in the fine powder discharging direction. The angle θ is defined to be positive in the direction in which the dispersion rotor 32 and the classification rotor 35 rotate. As described above, in the case of FIGS. 2(A) and 2(B), the dispersion rotor 32 and the classification rotor 35 rotate counterclockwise around M1. When the angle e is 1801, the loading direction and the discharging direction are identical to and parallel with each other. When the angle θ is 0°, the loading direction and the discharging direction are opposite to and parallel with each other.

The surface modification apparatus to be used in the present invention has the dispersion rotor 32, the loading portion 39 of a finely pulverized product (raw material), the classification rotor 35, and the fine powder discharging portion from the lower side in the vertical direction. Therefore, in general, a driving unit (a motor or the like) of the classification rotor 35 is arranged above the classification rotor 35 while a driving unit of the dispersion rotor 32 is arranged below the dispersion rotor 32. It is difficult for the surface modification apparatus to be used in the present invention to supply a finely pulverized product (raw material) from above the classification rotor 35 unlike a TSP classifier (manufactured by Hosokawa Micron Corporation) having only the classification rotor 35 described in JP 2001-259451 A, for example.

In the case of the surface modification apparatus to be used in the present invention, the raw material supplying direction and the fine powder discharging direction are preferably parallel with or substantially parallel with the rotation surface of the classification rotor 35 or of the dispersion rotor 32. When the fine powder discharging direction (suction direction) is parallel with or substantially parallel with the rotation surface of the classification rotor 35, the angle e between the raw material supplying direction and the fine powder discharging direction is important for obtaining particles each having a predetermined particle diameter in high yield. When the angle e between the raw material supplying direction and the fine powder discharging direction is adjusted, a finely pulverized product can be introduced into the classification zone 50 near the classification rotor 35 after agglomerated powder in the finely pulverized product as a raw material is finely dispersed favorably.

In the positional relationship between the loading portion of a finely pulverized product and the fine powder discharging portion, when the angle e is in the range of 0° to 180°, the suction force of the blower 364 tends to act via the classification rotor 35 before the agglomerated powder in the finely pulverized product is sufficiently finely dispersed by means of a spiral air flow formed by the dispersion rotor 32. In this case, there is a tendency that dispersion of the finely pulverized product loaded into the first space 47 becomes insufficient, the classification efficiency of fine powder and ultra-fine powder reduces, the classification time is prolonged, and hence the classification yield reduces. When the angle e is in the range of 210° to 330°, the following effect is exerted. The agglomerated powder in the finely pulverized product can be sufficiently finely dispersed by means of the spiral air flow formed by the dispersion rotor 32. In addition, a centrifugal force generated by the classification rotor effectively acts. As a result, a favorable classification yield can be obtained. The angle θ is preferably in the range of 225° to 315°, more preferably in the range of 250° to 290° in order that the above effect may be further exerted.

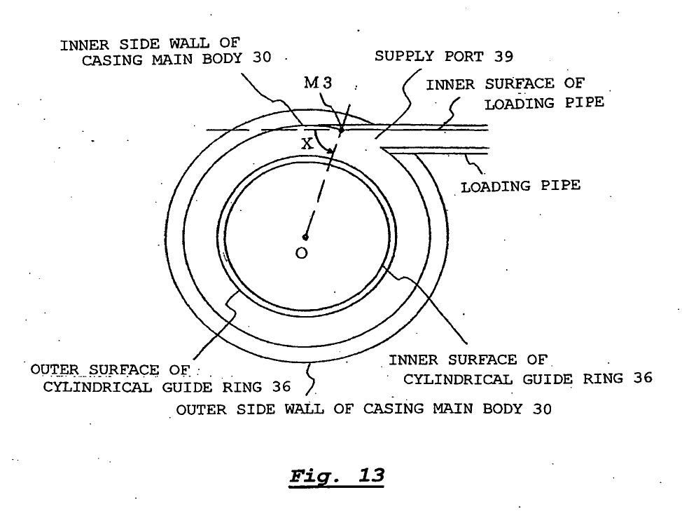

Setting the angle of the loading pipe having the supply port 39 with respect to the casing main body to fall within a predetermined range achieves an additional increase in classification yield. FIG. 13 shows a cross-section perpendicular to the center line in the vertical direction of the casing main body 30 of the surface modification apparatus and passing through the central position of the supply port 39. In the figure, an angle X, which is formed between: a straight line connecting an intersection point M3 of the inner face of the loading pipe having the supply port 39 and the inner side wall of the casing main body 30 and the center point O of the casing main body 30; and the inner face of the loading pipe, is preferably in the range of 60.0° to 90.0°. When the angle X is 0°, the loaded finely pulverized product vertically collides with the spiral air flow so that the finely pulverized product hardly rides on the spiral air flow formed in the first space 47 and hence the dispersibility of the finely pulverized product in the spiral air flow tends to reduce. Therefore, classification by means of the classification rotor 35 is performed without sufficient dispersion. As a result, classification accuracy easily reduces and the classification yield also easily reduces. The angle X is 90° at the maximum. When the angle X is smaller than 60.0°, the loaded finely pulverized product easily collides with the guide ring 36 so that the flow of the finely pulverized product is easily disturbed, thereby resulting in reduced classification yield. The angle X is more preferably in the range of 70.0° to 90.0°.

It is preferable that the tip peripheral speed of the classification rotor 35 rotating in a predetermined direction (a counterclockwise direction when viewed from the top face of the apparatus in FIG. 2(A)) be in the range of 30 to 120 m/sec and the tip peripheral speed of the dispersion rotor 32 rotating in the same direction as the direction in which the classification rotor 35 rotates be in the range of 20 to 150 m/sec. This is because the classification yield can be increased and the surface modification of particles can be performed efficiently with the tip peripheral speeds within such ranges.

FIG. 4 exemplify the position of the fine powder discharging pipe. A tangential type fine powder discharging pipe shown in FIG. 4(a) and a straight type fine powder discharging pipe shown in FIG. 4(b) can be used. When a finely pulverized product having a weight average particle diameter in the range of 3.5 to 7.5 μm and a specific gravity in the range of 1.0 to 1.5 g/cm³ is subjected to classification and surface modification, a tangential type fine powder discharging pipe having the same structure as that of a cyclone is more preferably used.

In the present invention, the tip peripheral speed of a portion having the largest diameter in the classification rotor 35 is preferably in the range of 30 to 120 m/sec. The tip peripheral speed of the classification rotor is more preferably in the range of 50 to 115 m/sec, still more preferably in the range of 70 to 110 m/sec. A tip peripheral speed of less than 30 m/sec is not preferable because the classification yield easily reduces and the amount of ultra-fine powder in the toner particles tends to increase. A tip peripheral speed in excess of 120 m/sec tends to increase the vibration of the apparatus.

Furthermore, the tip peripheral speed of a portion having the largest diameter in the dispersion rotor 32 is preferably in the range of 20 to 150 m/sec. The tip peripheral speed of the dispersion rotor 32 is more preferably in the range of 40 to 140 m/sec, still more preferably in the range of 50 to 130 m/sec. A tip peripheral speed of less than 20 m/sec is not preferable because it becomes difficult to obtain surface-modified particles each having a sufficient circularity. A tip peripheral speed in excess of 150 m/sec is not preferable either because the particles easily adhere inside the apparatus owing to an increase in temperature inside the apparatus and a reduction in classification yield of particles easily occurs. The classification yield of toner particles can be increased and the surface modification of particles can be performed efficiently by setting the tip peripheral speeds of the classification rotor 35 and the dispersion rotor 32 to fall within the above ranges.

A ratio R1/R2 of the tip peripheral speed R1 of the dispersion rotor 32 to the tip peripheral speed R2 of the classification rotor 35 in the range of 0.40 to 2.50 enables toner particles each having a high circularity to be efficiently obtained, resulting in improved classification yield. A ratio R1/R2 of less than 0.40 makes it difficult to obtain a sufficient circularity in a short time period so that toner particles having good quality may be hardly obtained. A ratio R1/R2 in excess of 2.50 is not preferable because the velocity of the spiral air flow formed by the dispersion rotor 32 relatively increases so that the spiral air flow around the classification rotor 35 is easily disturbed and hence the classification yield of toner particles reduces. The ratio R1/R2 is more preferably in the range of 0.85 to 2.45. The ratio R1/R2 is preferably in the range of 1.01 to 2.40 in order to efficiently obtain surface-modified toner particles having an average circularity in the range of 0.935 to 0.980 from a finely pulverized product having an average circularity of 0.929 or less.

In the process for producing a toner of the present invention, a finely pulverized product (raw material) to be supplied to the raw material loading port 37 of the surface modification apparatus preferably has a specific particle diameter distribution. Furthermore, the ultra-fine powder content in the toner particles after the treatment in the surface modification apparatus (surface-modified particles) is preferably controlled at a predetermined value. In the present invention, it is preferable that the finely pulverized product have a weight average particle diameter in the range of 3.5 to 9.0 μm and a ratio of particles each having a particle diameter of 4.00 μm or less in the range of 50 to 80% by number, and the resultant toner particles have a weight average particle diameter in the range of 4.5 to 9.0 μm, a ratio of particles each having a particle diameter of 4.00 μm or less (fine powder) in the range of 5 to 40% by number, and a ratio of toner particles each having a circle-equivalent diameter of 0.6 μm or more and less than 3 μm (ultra-fine powder) in the range of 0 to 15% by number in a number-basis particle diameter distribution of particles each having a circle-equivalent diameter, measured with a flow-type particle image measuring device, of 0.6 μm or more and 400 μm or less.

The particle diameter distribution of the finely pulverized product affects the classification efficiency. When the content of fine particles in the finely pulverized product is high, the classification time is prolonged and even particles which essentially do not have to be classified and removed are removed through classification. The above phenomenon may be responsible for a reduction in classification yield. Furthermore, agglomeration property of the finely pulverized product increases when classification is performed, and hence the case where ultra-fine powder which essentially has to be removed from the toner particles cannot be removed easily occurs. Therefore, the resultant toner easily causes fogging.

Therefore, a weight average particle diameter of the finely pulverized product of less than 3.5 μm may increase the agglomeration property between particles, thereby making it difficult to perform efficient classification. In addition, a weight average particle diameter of the finely pulverized product in excess of 9.0 μm is not preferable because it becomes difficult to form a sharp image with the resultant toner. In addition, a ratio of particles each having a particle diameter of 4.00 μm or less of less than 50% by number is not preferable because it becomes difficult to form a sharp image with the resultant toner. On the other hand, a ratio of particles each having a particle diameter of 4.00 μm or less of much more than 80% by number increases the agglomeration property of the finely pulverized product, thereby making it difficult to obtain a good classification yield. Furthermore, a ratio of particles each having a particle diameter of 4.00 μm or less of much more than 80% by number is not preferable because the content of ultra-fine powder in the finely pulverized product tends to increase. The ratio of particles each having a particle diameter of 4.00 μm or less in the finely pulverized product is more preferably in the range of 55 to 75% by number.

In a number-basis particle diameter distribution of particles each having a circle-equivalent diameter, measured with a flow-type particle image measuring device, of 0.6 μm or more and 400 μm or less out of the toner particles treated in the surface modification apparatus, a ratio of toner particles each having a circle-equivalent diameter of 0.6 μm or more and less than 3 μm (ultra-fine powder) is preferably controlled to fall within the range of 0 to 15% by number. A ratio of toner particles each having a circle-equivalent diameter of 0.6 μm or more and less than 3 μm in excess of 15% by number is not preferable because the resultant toner easily causes a fogging phenomenon. A ratio of toner particles each having a circle-equivalent diameter of 0.6 μm or more and less than 3 μm is more preferably 13% by number or less.

Furthermore, in the process for producing a toner of the present invention, the finely pulverized product to be introduced into the raw material loading port 37 preferably has a specific gravity in the range of 1.0 to 1.5.

When the classification yield of a finely pulverized product having a specific gravity in excess of 1.5 (for example, a finely pulverized product for preparing magnetic toner particles containing about 30% by mass or more of magnetic substance) and the classification yield of a finely pulverized product having a specific gravity of 1.5 or less (the finely pulverized product being nonmagnetic or containing a small amount of magnetic substance), are investigated by using a surface modification apparatus, in general, there is a tendency that the finely pulverized product having a specific gravity in excess of 1.5 can be more easily dispersed and hardly causes a reduction in classification yield. Therefore, when the finely pulverized product having a specific gravity of 1.5 or less is subjected to classification and surface modification, the effect of the use of the surface modification apparatus of the present invention tends to be further exerted as compared to the finely pulverized product having a specific gravity in excess of 1.5. In the present invention, the finely pulverized product more preferably has a specific gravity in the range of 1.0 to 1.5. The finely pulverized product having a specific gravity of less than 1.0 tends to increase cohesion between particles. Therefore, it becomes difficult to favorably disperse the finely pulverized product by means of a spiral air flow and hence the classification yield tends to reduce.

The term “surface modification” in the present invention means making the irregularities on the particle surface smooth, in other words, bringing the appearance of a particle close to a spherical shape. The present invention adopts an average circularity as an indication of the degree of surface modification of such a surface-modified particle.

The average circularity in the present invention is calculated by using the following expressions after measurement with a flow-type particle image measuring device “FPIA-2100” (manufactured by Sysmex Corporation).
Circle-equivalent diameter=(Particle projected area/π)^{1/2}×2

$$\begin{matrix}Circularity = ( Circumferential length of a circle having the same \\ area as the particle projected area ) / \\ ( Circumferential length of a particle projected \\ image )\end{matrix}$$

The term “particle projected area” is defined as an area of a binarized particle image whereas the term “circumferential length of a particle projected image” is defined as the length of a borderline obtained by connecting the edge points of the particle image. The measurement is performed by using the circumferential length of a particle image that has been subjected to image processing at an image processing resolution of 512 ×512 (a pixel measuring 0.3 μm×0.3 μm).

The circularity in the present invention is an indication of the degree of irregularities on a particle. The circularity is 1.000 when the particle has a completely spherical shape. The more complicated the surface shape, the lower the circularity.

In addition, the average circularity C which means the average value of a circularity frequency distribution is calculated from the following expression when the circularity (central value) of a divisional point i in a circularity distribution is denoted by ci and the number of measured particles is denoted by m.

Average circularity

$$C = {\sum }_{i = 1}^{m} ci / m$$

A circularity standard deviation SD is calculated from the following expression by using the average circularity C, the circularity ci of each particle, and the number m of measured particles.

Circularity standard deviation

$$SD = {\{ {\sum }_{i = 1}^{m} {( C - ci )}^{2} / m \}}^{1 / 2}$$

The measuring device “FPIA-2100”, which is used in the present invention, calculates the average circularity and the circularity standard deviation according to the following procedure. First, the circularities of the respective particles are calculated. Then, the particles are classified into classes, which are obtained by equally dividing the circularity range of 0.4 to 1.0 at an interval of 0.01, depending on the resultant circularities. After that, the average circularity and the circularity standard deviation are calculated by using the central value of each divisional point and the number of measured particles.

Specific measurement method is as follows. 20 ml of ion-exchanged water from which an impurity solid and the like have been removed in advance are prepared in a vessel. A surfactant (preferably alkylbenzene sulfonate) is added as a dispersant to the ion-exchanged water, and then a measurement sample is added to the ion-exchanged water in order that the content of the measurement sample will be 2,000 to 5,000 number/μl, and uniformly dispersed into the mixture. The resultant mixture is subjected to a dispersion treatment for 1 minutes by using an ultrasonic disperser “ULTRASONIC CLEANER VS-150” (manufactured by AS ONE Co., Ltd.) as dispersion means to prepare a dispersion for measurement. At that time, the dispersion is appropriately cooled in order that the temperature of the dispersion may not be 40° C. or higher. To suppress a variation in circularity, the temperature of an environment in which the flow-type particle image measuring device FPIA-2100 is placed is controlled at 23° C.±0.5° C. in such a manner that the temperature inside the device is in the range of 26 to 27° C. Automatic focusing is performed by using a 2-μm latex particle at a predetermined time interval, preferably at an interval of 2 hours.

Conditions for dispersion by means of ultrasonic oscillator are follows;
Device: ULTRASONIC CLEANER VS-150 (manufactured by AS ONE Co., Ltd.)
Rated output: 50 kHz, 150 W.

The flow-type particle image measuring device is used for the measurement of the circularity of a particle. The concentration of the dispersion is adjusted again in such a manner that the toner particle concentration at the time of measurement is in the range of 3,000 to 10,000 particles/μl, and 1,000 or more particles are measured. After the measurement, the average circularity of the particles is determined by using the data with data on particles each having a circle-equivalent diameter of less than 2 μm discarded.

The measuring device “FPIA-2100”, which is used in the present invention, has increased the accuracy of particle shape measurement as compared to a measuring device “FPIA-1000”, which has been used to calculate the shape of toner or a toner particle, by increasing the magnification of a processed particle image and by increasing the processing resolution of a captured image (256×256 to 512×512). As a result, the measuring device “FPIA-2100” has achieved more accurate capture of a fine particle. Therefore, the FPIA-2100 is more useful than the FPIA-1000 in the case where a particle shape must be measured more accurately as in the present invention.

The outline of the measurement in the present invention is as follows.

A sample dispersion is allowed to pass through a flow path (expanding along a flow direction) of a flat flow cell (having a thickness of about 200 μm). A stroboscope and a CCD camera are mounted on both sides of the flow cell in such a manner that an optical path passing while intersecting the thickness of the flow cell is formed. During the flow of the sample dispersion, light is applied from the stroboscope at an interval of 1/30 second in order to obtain the image of a particle flowing in the flow cell. As a result, each particle is photographed as a two-dimensional image having a certain area in parallel with the flow cell. The diameter of a circle having the same area as that of the two-dimensional image of each particle is calculated as a circle-equivalent diameter. Then, the circularity of each particle is calculated by using the above expression for the circularity from the projected area of the two-dimensional image of each particle and the circumferential length of the projected image.

In addition, in the present invention, a ratio of toner particles each having a circle-equivalent diameter of 0.6 μm or more and less than 3 μm is preferably in the range of 0 to 15% by number in a number-basis particle diameter distribution of toner particles (after a surface modification treatment) each having a circle-equivalent diameter, measured with a flow-type particle image measuring device, of 0.6 μm or more and 400 μm or less. A ratio of toner particles each having a circle-equivalent diameter in such a range is preferably in the range of 0 to 15% by number, more preferably in the range of 0 to 13% by number, still more preferably in the range of 0 to 11% by number. A toner particle having a circle-equivalent diameter of 0.6 μm or more and less than 3 μm significantly affects the developability of toner, in particular, the fogging property. Such a fine toner particle has excessively high chargeability so that the particle tends to be excessively developed at the time of development of the toner and appears as fogging on an image. However, in the present invention, a low ratio of such fine toner particles can alleviate fogging.

The ultra-fine powder content in the toner particles can also be suitably used as an evaluation criterion in the present invention because it has been recognized that the content has a correlation to fogging in a toner image. The ultra-fine powder content is determined from the % by number of particles each having a circle-equivalent diameter of 3.0 μm or less in a particle diameter distribution measured with the FPIA-2100. The presence amount of particles each having a circle-equivalent diameter of 3.0 μm or less is preferably 15% by number or less in order to favorably control a fogging level in image evaluation.

As shown in FIG. 12, a finely pulverized product can be obtained according to, for example, a method in which a coarsely pulverized product of a cooled product of a melt-kneaded product is classified and finely pulverized by using a conventionally known air impact pulverizer or mechanical pulverizer. Examples of such a mechanical pulverizer include a Turbo mill manufactured by Turbo Kogyo Co., Ltd., a Kryptron manufactured by Kawasaki Heavy Industries Ltd., an Innomizer manufactured by Hosokawa Micron Corporation, and a Super rotor manufactured by Nissin Engineering.

In addition, a finely pulverized product to be suitably used in the present invention can be obtained by using an I-DS pulverizer (manufactured by Nippon Pneumatic MFG. Co., Ltd.), an impact air pulverizer utilizing jet air shown in FIG. 1 of JP 2003-262981 A, and a classifier shown in FIG. 7 of JP 2003-262981 A. In this case, the pressure of a high-pressure gas to be used, which is typically in the range of 0.57 to 0.62 MPa, is preferably in the range of 0.40 to 0.55 MPa in terms of suppression of ultra-fine powder to be generated.

According to the process for producing a toner of the present invention, the average circularity of surface-modified particles obtained through a surface modification step can be greater than the average circularity of a finely pulverized product to be introduced into the surface modification step by 0.01 to 0.40. This is because the surface shape of a toner particle can be arbitrarily controlled by arbitrarily controlling the surface modification time of the surface modification apparatus. The use of the apparatus results in toner particles having an average circularity in the range of 0.935 to 0.980 (surface-modified particles). The average circularity is preferably in the range of 0.940 to 0.980 in terms of increase in transfer efficiency and prevention of occurrence of void in an image.

The particle diameter distribution of toner, which can be measured according to various methods, is measured by using the following measuring device in the present invention.

A Coulter Counter TA-II or Coulter Multisizer II (each manufactured by Beckman Coulter, Inc) is used as the measuring device. A 100-μm aperture is used as an aperture. The volume and number of toner are measured to calculate a volume distribution and a number distribution. Then, a weight average particle diameter based on a weight is determined from the volume distribution according to the present invention.

Next, the process for producing a toner of the present invention will be described briefly. In producing a toner in the present invention, first, a binder resin, a colorant, and a wax, and, as required, a charge-controlling agent and other additives are sufficiently mixed in a mixer such as a Henschell mixer or a ball mill, for example. Then, the resultant mixture is melted and kneaded by using a heat kneader such as a heat roll, a kneader, or an extruder to disperse or dissolve the colorant and the wax into the binder resin, thereby resulting in a kneaded product. The resultant kneaded product is cooled and solidified, and the solidified product is coarsely pulverized. After that, the coarsely pulverized product is finely pulverized by using an air impact pulverizer such as a jet mill or a mechanical impact pulverizer such as a Turbo mill or a Kryptron, thereby resulting in a finely pulverized product. Subsequently, the classification of the finely pulverized product and the surface treatment of the particles are simultaneously performed by using the batch-wise surface treatment apparatus as described above, thereby resulting in toner particles having a desired shape and a desired particle diameter distribution as surface-modified particles. The toner in the present invention is preferably toner containing an external additive obtained by externally adding the external additive to toner particles.

Next, components of the toner particles of the present invention containing a binder resin, a wax, and a colorant will be described. Various conventionally known materials of the toner particles may be used in the present invention.

Resins generally used for a toner may be used as the binder resin composing toner particle. The following may be given.

Examples of the binder resin used in the present invention include: polystyrene; homopolymers of styrene derivatives such as poly-p-chlorostyrene and polyvinyltolulene; styrene-based copolymers such as a styrene/p-chlorostyrene copolymer, a styrene/vinyltoluene copolymer, a styrene/vinylnaphthaline copolymer, a styrene/acrylate copolymer, a styrene/methacrylate copolymer, a styrene/methyl-α-chloromethacrylate copolymer, a styrene/acrylonitrile copolymer, a styrene/vinyl methyl ether copolymer, a styrene/vinyl ethyl ether copolymer, a styrene/vinyl methyl ketone copolymer, a styrene/butadiene copolymer, a styrene/isoprene copolymer, and a styrene/acrylonitrile/indene copolymer; polyvinyl chloride; a phenol resin; a natural modified phenol resin; a natural resin modified maleic resin; an acrylic resin; a methacrylic resin; a polyvinyl acetate; a silicone resin; a polyester resin; polyurethane; a polyamide resin; a furan resin; an epoxy resin; a xylene resin; a polyvinyl butyral; a terpene resin; a coumarone-indene resin; and a petroleum resin. In the present invention, a crosslinked styrene-based resin and a crosslinked polyester resin are preferably used as the binder resin when a particle is subjected to surface modification.

Examples of a comonomer for a styrene monomer of a styrene-based copolymer include: monocarboxylic acids each having a double bond and derivatives thereof, such as acrylic acid, methyl acrylate, ethyl acrylate, butyl acrylate, dodecyl acrylate, octyl acrylate, 2-ethylhexyl acrylate, phenyl acrylate, methacrylic acid, methyl methacrylate, ethyl methacrylate, butyl methacrylate, octyl methacrylate, acrylonitrile, methacrylonitrile, and acrylamide; dicarboxylic acids each having a double bond and derivatives thereof, such as maleic acid, butyl maleate, methyl maleate, and dimethyl maleate; vinyl esters such as vinyl chloride, vinyl acetate, and vinyl benzoate; ethylene-based olefins such as ethylene, propylene, and butylene; vinyl ketones such as vinyl methyl ketone and vinyl hexyl ketone; and vinyl ethers such as vinyl methyl ether, vinyl ethyl ether, and vinyl isobutyl ether. Those vinyl monomers may be used singly or as a mixture of two or more thereof.

Principal examples of a crosslinking agent include a compound having two or more polymerizable double bonds. Specific examples thereof include: aromatic divinyl compounds such as divinylbenzene and divinylnaphthalene; carboxylates each having two double bonds such as ethylene glycol diacrylate, ethylene glycol dimethacrylate, and 1,3-butanediol dimethacrylate; divinyl compounds such as divinylaniline, divinyl ether, divinyl sulfide, and divinyl sulfone; and compounds each having three or more vinyl groups. Those compounds may be used singly or as a mixture of two or more thereof.

With regard to toner physical property resulting from a binder resin, it is preferable that a molecular weight distribution of tetrahydrofuran (THF) soluble part measured by means of gel permeation chromatography (GPC) have at least one peak in a molecular weight region of 2,000 to 50,000, and a ratio of components each having a molecular weight of 1,000 to 30,000 be in the range of 50 to 90%.

Each of the following waxes is used as a material for the toner particles in the present invention in respect of enhancement of releasability from a fixing member and fixability at the time of fixation. Examples of the wax include: a paraffin wax and derivatives thereof; a microcrystalline wax and derivatives thereof; a Fischer-Tropsch wax and derivatives thereof; a polyolefin wax and derivatives thereof; and a carnauba wax and derivatives thereof. The derivatives of those waxes include: oxides, block copolymers with vinyl monomers, and graft-modified products. The waxes further include: alcohols, fatty acid, acid amides, esters, ketones, hardened castor oil and derivatives thereof, vegetable waxes, animal waxes, mineral waxes, and petrolatum.

In the present invention, a charge-controlling agent is preferably used as a component of the toner particles by incorporating the charge-controlling agent in the toner particles (internally adding) or mixing the charge-controlling agent with the toner particles (externally adding). Optimum charge amount control replied to a developing system may be obtained by the charge-controlling agent, and particularly a toner in which balance between a particle diameter distribution and a charge amount is more stabilized can be produced.

Examples of a negative charge-controlling agent that controls the toner to a negative charge include organometallic complexes and chelate compounds. Examples of the organometallic complexes include monoazo metal complexes, acetylacetone metal complexes, aromatic hydroxycarboxylic acid metal complexes, and aromatic dicarboxylic acid metal complexes. Further examples of the negative charge-controlling agent include: an aromatic hydroxycarboxylic acid, an aromatic monocarboxylic acid, an aromatic polycarboxylic acid, and metal salts thereof; anhydrides of an aromatic hydroxycarboxylic acid, an aromatic monocarboxylic acid, and an aromatic polycarboxylic acid; ester compounds of an aromatic hydroxycarboxylic acid, an aromatic monocarboxylic acid, and an aromatic polycarboxylic acid; and phenol derivatives such as bisphenol.

Examples of a positive charge-controlling agent that controls the toner to a positive charge include: nigrosine and modified products thereof with aliphatic acid metal salts; quaternary ammonium salts such as tributylbenzyl ammonium-1-hydroxy-4-naphthosulfonate and tetrabutyl ammonium tetrafluoroborate, and lake pigments thereof; phosphonium salts such as tributylbenzyl phosphonium-1-hydroxy-4-naphthosulfonate and tetrabutyl phosphonium tetrafluoroborate, and lake pigments thereof; triphenylmethane dyes and lake pigments thereof (the laking agents include phosphotungstic acid, phosphomolybdic acid, phosphotungsten molybdic acid, tannic acid, lauric acid, gallic acid, ferricyanates, and ferrocyanates); metal salts of higher aliphatic acids; diorganotin oxides such as dibutyltin oxide, dioctyltin oxide, and dicyclohexyltin oxide; and diorganotin borates such as dibutyltin borate, dioctyltin borate, and dicyclohexyltin borate. Those positive charge-controlling agents may be used singly or as a mixture of two or more thereof.

The above charge-controlling agents are preferably used in fine particle states. In this case, the number average particle diameter of those charge-controlling agents is preferably 4 μm or less, particularly preferably 3 μm or less. When the charge-controlling agents are internally added to the toner particles the an amount thereof is preferably 0.1 to 20 parts by mass, more preferably 0.2 to 10 parts by mass with respect to 100 parts by mass of the binder resin.

In the present invention, any one of various conventionally known colorants can be used as a component of the toner particles. A black colorant to be used in the present invention is carbon black or a magnetic substance, or a colorant toned to a black color by combining chromatic colorants such as a yellow colorant, a magenta colorant, and a cyan colorant as described below.

Examples of the yellow colorant include compounds represented by condensed azo compounds, isoindolinone compounds, anthraquinone compounds, azo metal complexes, methine compounds, and allylamide compounds. Specific examples thereof include C.I. Pigment Yellow 12, 13, 14, 15, 17, 62, 74, 83, 93, 94, 95, 97, 109, 110, 111, 120, 127, 128, 129, 147, 168, 174, 176, 180, 181, and 191.

Examples of the magenta colorant include condensed azo compounds, diketopyrolopyrrole compounds, anthraquinone compounds, quinacridone compounds, basic dye lake compounds, naphthol compounds, benzimidazolone compounds, thioindigo compounds, and perylene compounds. Specific examples thereof include C.I. Pigment Red 2, 3, 5, 6, 7, 23, 48:2, 48:3, 48:4, 57:1, 81:1, 144, 146, 166, 169, 177, 184, 185, 202, 206, 220, 221, and 254.

Examples of the cyan colorant include: copper phthalocyanine compounds and derivatives thereof; anthraquinone compounds; and basic dye lake compounds. Specific examples thereof include C.I. Pigment Blue 1, 7, 15, 15:1, 15:2, 15:3, 15:4, 60, 62, and 66.

Each of those colorants may be used alone or may be mixed with another colorant before use. Furthermore, each of those colorants may be used in a solid solution state. In the present invention, a colorant is selected in view of hue angle, chroma, brightness, weatherability, OHP transparency, and dispersability in toner. Toner particles contain 1 to 20 parts by mass in total of those chromatic and nonmagnetic colorants or carbon black with respect to 100 parts by mass of the binder resin. When the magnetic substance is used as the colorant, 20 to 200 parts by mass with respect to 100 parts by mass of the binder resin is preferably contained.

Furthermore, toner can be obtained by: externally adding/mixing an external additive such as conventionally known inorganic fine powder to/with toner particles for improving flowability, transferability, and the like; and subjecting the mixture to a conventionally known sieving step.

Hereinafter, a process for producing a toner of the present invention will be described in more detail by way of examples and comparative examples. However, the present invention is not limited to these examples.

### EXAMPLE 1

Unsaturated polyester resin [Unsaturated polyester resin constituted of polyoxypropylene(2.2)-2,2-bis(4-hydroxyphenyl)propane/polyoxyethylene(2.2)-2,2-bis(4-hydroxyphenyl)propane/terephthalic acid/trimellitic anhydride/fumaric acid, Mw: 17,000, Mw/Mn: 4.5, Tg: 60° C.]
100 parts by mass Copper phthalocyanine pigment (C.I. Pigment Blue 15:3):
4 parts by mass Paraffin wax (maximum endothermic peak: 73° C.):
5 parts by mass Charge-controlling agent (salicylic acid metal complex E-88 (available from Orient Co.))
4 parts by mass The above materials were sufficiently mixed with a Henschell mixer (FM-75, manufactured by Mitsui-Miike Chemical Engineering Service Inc.) and then kneaded with a biaxial kneader (PCM-30, manufactured by Ikegai Tekko Co., Ltd.) set at 110° C. The resultant kneaded product was cooled and coarsely pulverized with a hammer mill into pieces each having a size of 1 mm or less to obtain a coarsely pulverized product.

The coarsely pulverized product was finely pulverized by using a jet mill utilizing jet air shown in FIG. 12 (IDS-5 pulverizer, manufactured by Nippon Pneumatic MFG. Co., Ltd.) at a feeding rate of 3 kg/hr and an air pressure of 0.5 MPa to obtain a finely pulverized product. The finely pulverized product had a weight average particle diameter D4 of 5.2 μm, a ratio of particles each having a particle diameter of 4.00 μm or less of 70% by number, an average circularity of 0.925, and a specific gravity of 1.2 g/cm³.

The resultant finely pulverized product was loaded into the batch-wise surface modification apparatus shown in FIGS. 1 and 10 to simultaneously perform the classification and surface modification of the finely pulverized product. In Example 1, the surface modification apparatus, in which the raw material supply port 39 and the fine powder discharging port 45 were set in such a manner that the angle θ formed between L1 and L2 was 270° as shown in FIG. 2(B), was used, the loading pipe was placed at a position shown in FIG. 2(B) and FIG. 13 (angle X=70°), and the fine powder discharging pipe having the fine powder discharging port 45 was placed at a position shown in FIG. 4(A). In FIGS. 1 and 10, the fine powder discharging pipe having the fine powder discharging port 45 was placed behind the apparatus.

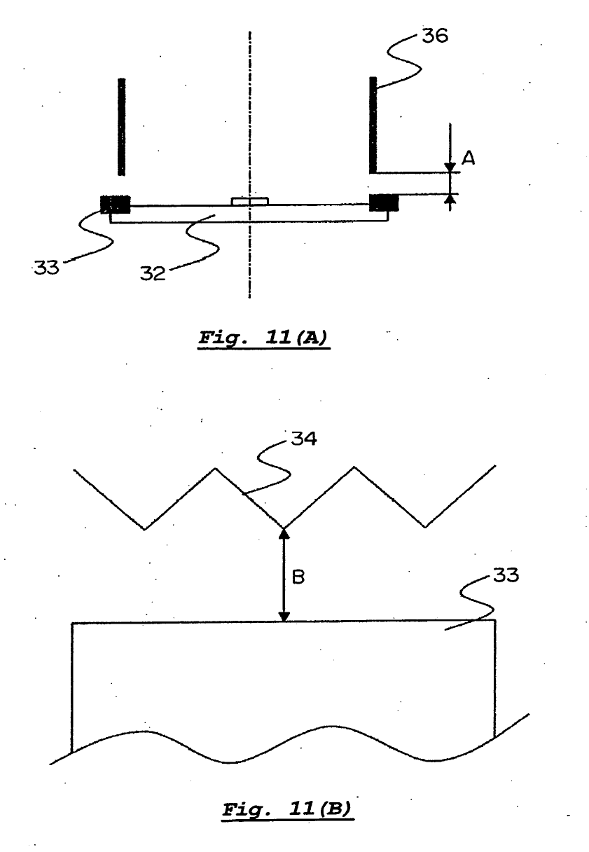

In Example 1, the outer diameter D of the dispersion rotor 32 shown in FIG. 6(A) was set at 400 mm and 12 square disks 33 shown in FIGS. 8(A) and 8(B) were placed on an upper portion of the dispersion rotor 32. Each of the square disks 33 measured 40 mm long (L) by 20 mm wide (W) by 30 mm high (H). The rotational peripheral speed R1 of the dispersion rotor 32 rotating counterclockwise when viewed from above was set at 83 m/sec. The inner diameter d of the cylindrical guide ring 36 shown in FIGS. 7(A) and 7(B) was set at 350 mm, a gap A shown in FIG. 11(A) between a lower end of the guide ring 36 and an upper end of each of the square disks 33 on the top of the dispersion rotor 32 was set at 5 mm, and a gap B shown in FIG. 11(B) between each of the square disks 33 on the top of the dispersion rotor 32 and an apex of a triangular tooth of the liner 34 was set at 3 mm. The inner diameter D of the liner 34 was 406 mm. The blade diameter D of the classification rotor 35 shown in FIGS. 5(A) and 5(B) was set at 240 mm, the blade length L of the classification rotor 35 was set at 130 mm, and the rotational peripheral speed R2 of the classification rotor 35 rotating counterclockwise when viewed from above was set at 81 m/sec. Therefore, a ratio (R1/R2) of the peripheral speed R1 of the dispersion rotor 32 to the peripheral speed R2 of the classification rotor 35 was 1.02. The height H of the liner 34 shown in FIGS. 9(A) and 9(B) was set at 80 mm. A time for one cycle of the classification and surface treatment of the finely pulverized product was set at 60 sec (loading time: 10 sec, treating time: 30 sec, and discharging time: 20 sec), and a feeding rate of the finely pulverized product was set at 65 kg/hr (therefore, a feeding amount per cycle was about 1.08 kg). The intake air volume of the blower 364 was set at 22 m³/min, the temperature T1 of the cold air was set at −20° C., and the temperature of cold water to be allowed to pass through the cooling jacket was set at −10° C.

The apparatus was operated in this state for 12 minutes. As a result, the temperature T2 inside the fine powder discharging pipe behind the classification rotor 35 was stably 25° C. ΔT (T2−T1) was 45° C. The classification yield was 69%.

The particle diameter distribution and circularity of the resultant surface-modified toner particles were measured. As a result, the toner particles had a weight average particle diameter D4 of 5.8 μm, a ratio of particles each having a particle diameter of 4.00 μm or less of 25% by number, and a ratio of particles each having a circle-equivalent diameter of 0.6 μm or more and less than 3 μm of 6% by number. The average circularity of the surface-modified toner particles was 0.952.

The positional relationship between the raw material supply port 39 and the fine powder discharging port 45 in the fine powder discharging casing 44 was set to be in an optimum state. As a result, as compared with the comparative examples to be described later, the classification yield were higher and the ultra-fine powder content (a ratio of particles each having a circle-equivalent diameter of 0.6 μm or more and less than 3 μm) in the toner particle in Example 1 were lower. Accordingly, good results were obtained.

1.2 parts by mass of hydrophobic silica fine powder were externally added to and mixed with 100 parts by mass of the resultant surface-modified toner particles to obtain toner. 5 parts by mass of the resultant toner and 95 parts by mass of acrylic resin-coated magnetic ferrite carriers were mixed to prepare a two-component developer. 10,000-sheet endurance image output was performed by using the two-component developer and a remodeled device of a full-color copying machine CLC 1000 manufactured by Canon Inc. (obtained by removing an oil application mechanism from a fixing unit). The fogging level after endurance image output of a large number of sheets was evaluated according to the following evaluation criteria. Table 1 shows the operating conditions for the surface modification apparatus used at the time of production of toner particles while Table 2 shows the results of evaluation. Example 1 showed good results of evaluation as compared to the comparative examples to be described later. This is probably because the ultra-fine powder content (a ratio of particles each having a circle-equivalent diameter of 0.6 μm or more and less than 3 μm) was controlled at an appropriate value.

Fogging was evaluated according to the following procedure. The average reflectivity Dr (%) of plain paper before image output was measured with a reflectometer (TC-6DS manufactured by Tokyo Denshoku). A solid white image (Vback: 150 V) was outputted onto the plain paper, and then the reflectivity Ds (%) of the solid white image was measured, followed by calculation of Dr−Ds. The resultant value of Dr−Ds was defined as a value of fogging and evaluated according to the following evaluation criteria.

[Evaluation Criteria]

A: extremely good level (less than 0.6%)

B: good level (0.6% or more and less than 1.2%)

C: acceptable level (1.2% or more and less than 3.0%)

D: bad level (3.0% or more)

### COMPARATIVE EXAMPLE 1

Toner particles were produced in the same manner as in Example 1 except that: the positional relationship between the raw material supply port 39 and the fine powder discharging port 45 (the angle e formed between L1 and L2) shown in FIG. 2(A) was set at 180°; and the loading pipe was placed in the casing main body 30 in such a manner that the angle X shown in FIG. 13 would be 0°. The resultant toner particles were used to prepare a two-component developer in the same manner as in Example 1, followed by image output evaluation. Table 1 shows the operating conditions for the surface modification apparatus used while Table 2 shows the results. The results were inferior to those of Example 1.

TABLE 1
Operating conditions for surface modification apparatus
of Example 1 and Comparative Example 1

| | | | | Comparative |
|---|---|---|---|---|
| | | | Example 1 | Example 1 |
| Surface | Angle θ formed between L1 | [°] | 270 | 180 |
| modification | and L2 | | | |
| apparatus (FIG. 1) | Position of fine powder | | (A) | (A) |
| | discharging pipe | | | |
| | Outer diameter of | [mm] | 400 | 400 |
| | dispersion rotor | | | |
| | Blade diameter of | [mm] | 240 | 240 |
| | classification rotor | | | |
| | Blade length of | [mm] | 130 | 130 |
| | classification rotor | | | |
| | Number of square disks on | | 12 | 12 |
| | dispersion rotor | | | |
| | Dimension L of square disk | [mm] | 40 | 40 |
| | Dimension W of square disk | [mm] | 20 | 20 |
| | Dimension H of square disk | [mm] | 30 | 30 |
| | Inner diameter of guide | [mm] | 350 | 350 |
| | ring | | | |
| | Distance between guide ring | [mm] | 5 | 5 |
| | and disk | | | |
| | Distance between disk and | [mm] | 3 | 3 |
| | liner | | | |
| | Peripheral speed R1 of | [m/sec] | 120 | 120 |
| | dispersion rotor | | | |
| | Peripheral speed R2 of | [m/sec] | 81 | 81 |
| | classification rotor | | | |
| | R1/R2 | | 1.48 | 1.48 |
| | Loading time | [sec] | 10 | 10 |
| | Treating time | [sec] | 30 | 30 |
| | Discharging time | [sec] | 20 | 20 |
| | Time for 1 cycle | [sec] | 60 | 60 |
| | Cold air temperature T1 | [° C.] | −20 | −20 |
| | Outlet temperature T2 | [° C.] | 25 | 25 |
| | ΔT (T2 − T1) | [° C.] | 45 | 45 |
| | Temperature of cooling | [° C.] | −10 | −10 |
| | jacket | | | |
| | Blower air volume | [m3/min] | 22 | 22 |
| | Feeding rate | [kg/hr] | 65 | 65 |
| | Feeding amount per cycle | [kg/cyc] | 1.08 | 1.08 |

TABLE 2
Physical properties and results of evaluation of
Example 1 and Comparative Example 1

| | | | | Compara- |
|---|---|---|---|---|
| | | | | tive |
| | | | Example 1 | Example 1 |
| Results | Weight average particle | [μm] | 5.2 | 5.2 |
| after fine | diameter | | | |
| pulveri- | Ratio of particles each | [%] | 70 | 70 |
| zation | having a particle diameter | | | |
| | of 4.0 μm or less | | | |
| | (% by number) | | | |
| | Specific gravity | | 1.2 | 1.2 |
| Results | Classification yield | [%] | 75 | 55 |
| after | Weight average particle | [μm] | 5.8 | 5.8 |
| surface | diameter | | | |
| modifi- | Ratio of particles each | [%] | 25 | 28 |
| cation | having a particle diameter | | | |
| treatment | of 4.0 μm or less | | | |
| | (% by number) | | | |
| | Ratio of particles each | [%] | 6 | 17 |
| | having a particle diameter | | | |
| | of 3.0 μm or less | | | |
| | (% by number) | | | |
| | Average circularity | | 0.952 | 0.939 |
| Results of | Fogging | | A | C |
| evaluation | | | | |

### EXAMPLE 2

Toner particles were produced in the same manner as in Example 1 except that the positional relationship between the raw material supply port 39 and the fine powder discharging port 45 (the angle e formed between L1 and L2) shown in FIG. 2(B) was set at 210°. The resultant toner particles were used to prepare a two-component developer in the same manner as in Example 1, followed by image output evaluation. Table 3 shows the operating conditions for the surface modification apparatus used while Table 4 shows the results.

### EXAMPLE 3

Toner particles were produced in the same manner as in Example 1 except that the positional relationship between the raw material supply port 39 and the fine powder discharging port 45 (the angle e formed between L1 and L2) shown in FIG. 2(B) was set at 220°. The resultant toner particles were used to prepare a two-component developer in the same manner as in Example 1, followed by image output evaluation. Table 3 shows the operating conditions for the surface modification apparatus used while Table 4 shows the results.

### EXAMPLE 4

Toner particles were produced in the same manner as in Example 1 except that the positional relationship between the raw material supply port 39 and the fine powder discharging port 45 (the angle θ formed between L1 and L2) shown in FIG. 2(B) was set at 315°. The resultant toner particles were used to prepare a two-component developer in the same manner as in Example 1, followed by image output evaluation. Table 3 shows the operating conditions for the surface modification apparatus used while Table 4 shows the results.

### EXAMPLE 5

Toner particles were produced in the same manner as in Example 1 except that the shape of the upper portion of the fine powder discharging port in the batch-wise surface modification apparatus was changed to a straight type shown in FIG. 4(B). The resultant toner particles were used to prepare a two-component developer in the same manner as in Example 1, followed by image output evaluation. Table 3 shows the operating conditions for the surface modification apparatus used while Table 4 shows the results.

### COMPARATIVE EXAMPLE 2

Toner particles were produced in the same manner as in Example 1 except that the positional relationship between the raw material supply port 39 and the fine powder discharging port 45 (the angle θ formed between L1 and L2) shown in FIG. 2(A) was set at 0°, and the loading pipe was placed in the casing main body 30 in such a manner that the angle X shown in FIG. 13 would be 0°. The resultant toner particles were used to prepare a two-component developer in the same manner as in Example 1, followed by image output evaluation. Table 3 shows the operating conditions for the surface modification apparatus used while Table 4 shows the results. The results were inferior to those of examples described above.

TABLE 3
Operating conditions for surface modification apparatus of Examples 2 to 5 and Comparative
Example 2

| | | | | | | | Comparative |
|---|---|---|---|---|---|---|---|
| | | | Example 2 | Example 3 | Example 4 | Example 5 | Example 2 |
| Surface | Angle θ formed between L1 and L2 | [°] | 210 | 220 | 315 | 270 | 0 |
| modification | Position of fine powder discharging pipe | | (A) | (A) | (A) | (B) | (A) |
| apparatus | Outer diameter of dispersion rotor | [mm] | 400 | 400 | 400 | 400 | 400 |
| (FIG. 1) | Blade diameter of classification rotor | [mm] | 240 | 240 | 240 | 240 | 240 |
| | Blade length of classification rotor | [mm] | 130 | 130 | 130 | 130 | 130 |
| | Number of square disks on dispersion rotor | | 12 | 12 | 12 | 12 | 12 |
| | Dimension L of square disk | [mm] | 40 | 40 | 40 | 40 | 40 |
| | Dimension W of square disk | [mm] | 20 | 20 | 20 | 20 | 20 |
| | Dimension H of square disk | [mm] | 30 | 30 | 30 | 30 | 30 |
| | Inner diameter of guide ring | [mm] | 350 | 350 | 350 | 350 | 350 |
| | Distance between guide ring and disk | [mm] | 5 | 5 | 5 | 5 | 5 |
| | Distance between disk and liner | [mm] | 3 | 3 | 3 | 3 | 3 |
| | Peripheral speed R1 of dispersion rotor | [m/sec] | 83 | 83 | 83 | 83 | 83 |
| | Peripheral speed R2 of classification rotor | [m/sec] | 81 | 81 | 81 | 81 | 81 |
| | R1/R2 | | 1.02 | 1.02 | 1.02 | 1.02 | 1.02 |
| | Loading time | [sec] | 10 | 10 | 10 | 10 | 10 |
| | Treating time | [sec] | 30 | 30 | 30 | 30 | 30 |
| | Discharging time | [sec] | 20 | 20 | 20 | 20 | 20 |
| | Time for 1 cycle | [sec] | 60 | 60 | 60 | 60 | 60 |
| | Cold air temperature T1 | [° C.] | −20 | −20 | −20 | −20 | −20 |
| | Outlet temperature T2 | [° C.] | 26 | 27 | 27 | 32 | 31 |
| | ΔT (T2 − T1) | [° C.] | 46 | 47 | 47 | 52 | 51 |
| | Temperature of cooling jacket | [° C.] | −10 | −10 | −10 | −10 | −10 |
| | Blower air volume | [m³/min] | 22 | 22 | 22 | 22 | 22 |
| | Feeding rate | [kg/hr] | 65 | 65 | 65 | 65 | 65 |
| | Feeding amount per cycle | [kg/cyc] | 1.08 | 1.08 | 1.08 | 1.08 | 1.08 |

TABLE 4
Physical properties and results of evaluation of Examples 2 to 5 and Comparative Example 2

| | | | | | | | Comparative |
|---|---|---|---|---|---|---|---|
| | | | Example 2 | Example 3 | Example 4 | Example 5 | Example 2 |
| Results after | Weight average particle diameter | [μm] | 5.2 | 5.2 | 5.2 | 5.2 | 5.2 |
| fine | Ratio of particles each having a particle | [%] | 70 | 70 | 70 | 70 | 70 |
| pulverization | diameter of 4.0 μm or less | | | | | | |
| | (% by number) | | | | | | |
| | Specific gravity | | 1.2 | 1.2 | 1.2 | 1.2 | 1.2 |
| Results after surface | Classification yield | [%] | 68 | 68 | 73 | 66 | 53 |
| modification treatment | Weight average particle diameter | [μm] | 5.8 | 5.8 | 5.8 | 5.7 | 5.6 |
| | Ratio of particles each having a particle | [%] | 26 | 27 | 27 | 29 | 33 |
| | diameter of 4.0 μm or less | | | | | | |
| | (% by number) | | | | | | |
| | Ratio of particles each having a particle | [%] | 7 | 8 | 7 | 10 | 16 |
| | diameter of 3.0 μm or less | | | | | | |
| | (% by number) | | | | | | |
| | Average circularity | | 0.933 | 0.933 | 0.933 | 0.933 | 0.932 |
| Results of | Fogging | | B | B | B | B | C |
| evaluation | | | | | | | |

### EXAMPLE 6

The coarsely pulverized product obtained in Example 1 was finely pulverized by using a jet mill utilizing jet air shown in FIG. 12 (IDS-5 pulverizer, manufactured by Nippon Pneumatic MFG. Co., Ltd.) at a feeding rate of 6 kg/hr and an air pressure of 0.5 MPa to obtain a finely pulverized product. The finely pulverized product had a weight average particle diameter D4 of 7.2 μm, a ratio of particles each having a particle diameter of 4.00 μm or less of 60% by number, an average circularity of 0.924, and a specific gravity of 1.2 g/cm³.

The resultant finely pulverized product was loaded into the batch-wise surface modification apparatus shown in FIGS. 1 and 10 to simultaneously perform the classification and surface modification of the finely pulverized product. In Example 1, the surface modification apparatus, in which the raw material supply port 39 and the fine powder discharging port 45 were set in such a manner that the angle θ formed between L1 and L2 was 270° as shown in FIG. 2(B), was used, the loading pipe was placed at a position shown in FIG. 2(B) and FIG. 13 (angle X=70°), and the fine powder discharging pipe having the fine powder discharging port 45 was placed at a position shown in FIG. 4(A). In FIGS. 1 and 10, the fine powder discharging pipe having the fine powder discharging port 45 was placed behind the apparatus.

In Example 1, the outer diameter D of the dispersion rotor 32 shown in FIG. 6(A) was set at 400 mm and 12 square disks 33 shown in FIGS. 8(A) and 8(B) were placed on an upper portion of the dispersion rotor 32. Each of the square disks 33 measured 40 mm long (L) by 20 mm wide (W) by 30 mm high (H). The rotational peripheral speed R1 of the dispersion rotor 32 was set at 111 m/sec. The inner diameter d of the cylindrical guide ring 36 shown in FIGS. 7(A) and 7(B) was set at 350 mm, a gap A shown in FIG. 11(A) between a lower end of the guide ring 36 and an upper end of each of the square disks 33 on the top of the dispersion rotor 32 was set at 5 mm, and a gap B shown in FIG. 11(B) between each of the square disks 33 on the top of the dispersion rotor 32 and an apex of a triangular tooth of the liner 34 was set at 3 mm The blade diameter D of the classification rotor 35 shown in FIGS. 5(A) and 5(B) was set at 240 mm, the blade length L of the classification rotor 35 was set at 130 mm, and the rotational peripheral speed R2 of the classification rotor 35 was set at 81 m/sec. The ratio (R1/R2) of the peripheral speed R1 of the dispersion rotor 32 to the peripheral speed R2 of the classification rotor 35 was 1.37. The height H of the liner 34 shown in FIGS. 9(A) and 9(B) was set at 80 mm. A time for one cycle of the classification and surface treatment of the finely pulverized product was set at 60 sec (loading time: 10 sec, treating time: 30 sec, and discharging time: 20 sec), and a feeding rate of the finely pulverized product was set at 75 kg/hr (therefore, a feeding amount per cycle was about 1.25 kg). The intake air volume of the blower 364 was set at 21 m³/min, the temperature T1 of the cold air was set at −20° C., and the temperature of cold water to be allowed to pass through the cooling jacket was set at −10° C.

The apparatus was operated in this state for 12 minutes. As a result, the temperature T2 behind the classification rotor 35 was stably 30° C. ΔT (T2−T1) was 50° C. The classification yield was 73%.

The particle diameter distribution and circularity of the resultant surface-modified toner particles were measured. As a result, the toner particles had a weight average particle diameter D4 of 7.2 μm, a ratio of particles each having a particle diameter of 4.00 μm or less of 11% by number, and a ratio of particles each having a circle-equivalent diameter of 0.6 μm or more and less than 3 μm of 5% by number. The average circularity of the surface-modified toner particles was 0.935.

The positional relationship between the raw material supply port 39 and the fine powder discharging port 45 in the fine powder discharging casing 44 was set to be in an optimum state. As a result, as compared with the comparative examples to be described later, the classification yield were higher and the ultra-fine powder content (a ratio of particles each having a circle-equivalent diameter of 0.6 μm or more and less than 3 μm) in the toner particle in Example 1 were lower. Accordingly, good results were obtained.

1.2 parts by mass of hydrophobic silica fine powder were externally added to and mixed with 100 parts by mass of the resultant toner particles to obtain toner. 5 parts by mass of the resultant toner and 95 parts by mass of acrylic resin-coated magnetic ferrite carriers were mixed to prepare a two-component developer. 10,000-sheet endurance image output was performed by using the developer and a remodeled device of a full-color copying machine CLC 1000 manufactured by Canon Inc. (obtained by removing an oil application mechanism from a fixing unit). The fogging level after endurance image output was evaluated according to the evaluation criteria as above described. Table 5 shows the operating conditions for the surface modification apparatus used while Table 6 shows the results of evaluation. Example 6 showed good results of evaluation as compared to the comparative examples to be described later. This is probably because the ultra-fine powder content (a ratio of particles each having a circle-equivalent diameter of 0.6 μm or more and less than 3 μm) was controlled at an appropriate value.

### EXAMPLE 7

Toner particles were produced in the same manner as in Example 6 except that, in the operating conditions for the surface modification apparatus, the rotational peripheral speed R1 of the dispersion rotor 32 was set at 146 m/sec, the rotational peripheral speed R2 of the classification rotor 35 was set at 63 m/sec (peripheral speed R1 of the dispersion rotor/peripheral speed R2 of the classification rotor=2.30), and the blower air volume was set at 23 m³/min. The resultant toner particles were used to prepare a two-component developer in the same manner as in Example 1, followed by image output evaluation. Table 5 shows the operating conditions for the surface modification apparatus used while Table 6 shows the results.

### EXAMPLE 8

Toner particles were produced in the same manner as in Example 6 except that, in the operating conditions for the surface modification apparatus, the rotational peripheral speed R1 of the dispersion rotor 32 was set at 41 m/sec, the rotational peripheral speed R2 of the classification rotor 35 was set at 29 m/sec (peripheral speed R1 of the dispersion rotor/peripheral speed R2 of the classification rotor=0.43), and the blower air volume was set at 23 m³/min. The resultant toner particles were used to prepare a two-component developer in the same manner as in Example 1, followed by image output evaluation. Table 5 shows the operating conditions for the surface modification apparatus used while table 6 shows the results.

### COMPARATIVE EXAMPLE 3

Toner particles were produced in the same manner as in Example 6 except that: the positional relationship between the raw material supply port 39 and the fine powder discharging port 45 (the angle θ formed between L1 and L2) shown in FIG. 2(A) was set at 180°; and the loading pipe was placed in the casing main body 30 in such a manner that the angle X shown in FIG. 13 would be 0°. The resultant toner particles were used to prepare a two-component developer in the same manner as in Example 1, followed by image output evaluation. Table 5 shows the operating conditions for the surface modification apparatus used while Table 6 shows the results. The results were inferior to those of Example 6.

TABLE 5
Operating conditions for surface modification apparatus of Examples 6 to 8 and Comparative
Example

| | | | | | | Comparative |
|---|---|---|---|---|---|---|
| | | | Example 6 | Example 7 | Example 8 | Example 3 |
| Surface | Angle θ formed between L1 and L2 | [°] | 270 | 270 | 270 | 180 |
| modification | Position of fine powder discharging pipe | | (A) | (A) | (A) | (A) |
| apparatus | Outer diameter of dispersion rotor | [mm] | 400 | 400 | 400 | 400 |
| (FIG. 1) | Blade diameter of classification rotor | [mm] | 240 | 240 | 240 | 240 |
| | Blade length of classification rotor | [mm] | 130 | 130 | 130 | 130 |
| | Number of square disks on dispersion rotor | | 12 | 12 | 12 | 12 |
| | Dimension L of square disk | [mm] | 40 | 40 | 40 | 40 |
| | Dimension W of square disk | [mm] | 20 | 20 | 20 | 20 |
| | Dimension H of square disk | [mm] | 30 | 30 | 30 | 30 |
| | Inner diameter of guide ring | [mm] | 350 | 350 | 350 | 350 |
| | Distance between guide ring and disk | [mm] | 5 | 5 | 5 | 5 |
| | Distance between disk and liner | [mm] | 3 | 3 | 3 | 3 |
| | Peripheral speed R1 of dispersion rotor | [m/sec] | 111 | 146 | 41 | 111 |
| | Peripheral speed R2 of classification rotor | [m/sec] | 81 | 63 | 94 | 81 |
| | R1/R2 | | 1.37 | 2.32 | 0.44 | 1.37 |
| | Loading time | [sec] | 10 | 10 | 10 | 10 |
| | Treating time | [sec] | 30 | 30 | 30 | 30 |
| | Discharging time | [sec] | 20 | 20 | 20 | 20 |
| | Time for 1 cycle | [sec] | 60 | 60 | 60 | 60 |
| | Cold air temperature T1 | [° C.] | −20 | −20 | −20 | −20 |
| | Outlet temperature T2 | [° C.] | 30 | 35 | 20 | 32 |
| | ΔT (T2 − T1) | [° C.] | 50 | 55 | 40 | 52 |
| | Temperature of cooling jacket | [° C.] | −10 | −10 | −10 | −10 |
| | Blower air volume | [m³/min] | 21 | 23 | 23 | 21 |
| | Feeding rate | [kg/hr] | 75 | 75 | 75 | 75 |
| | Feeding amount per cycle | [kg/cyc] | 1.25 | 1.25 | 1.25 | 1.25 |

TABLE 6
Physical properties and results of evaluation of Examples 6 to 8 and Comparative Example 3

| | | | | | | Comparative |
|---|---|---|---|---|---|---|
| | | | Example 6 | Example 7 | Example 8 | Example 3 |
| Results after | Weight average particle diameter | [μm] | 7.2 | 7.2 | 7.2 | 7.2 |
| fine | Ratio of particles each having a particle | [%] | 60 | 60 | 60 | 60 |
| pulverization | size of 4.0 μm or less | | | | | |
| | (% by number) | | | | | |
| | Specific gravity | | 1.2 | 1.2 | 1.2 | 1.2 |
| Results after surface | Classification yield | [%] | 73 | 67 | 74 | 66 |
| modification treatment | Weight average particle diameter | [μm] | 7.6 | 7.7 | 7.5 | 7.6 |
| | Ratio of particles each having a particle | [%] | 11 | 9 | 13 | 14 |
| | diameter of 4.0 μm or less | | | | | |
| | (% by number) | | | | | |
| | Ratio of particles each having a particle | [%] | 5 | 12 | 5 | 12 |
| | diameter of 3.0 μm or less | | | | | |
| | (% by number) | | | | | |
| | Average circularity | | 0.935 | 0.945 | 0.923 | 0.935 |
| Results of | Fogging | | A | B | A | C |
| evaluation | | | | | | |

### COMPARATIVE EXAMPLE 4

The classification and surface modification of the finely pulverized product were performed in the same manner as in Example 1 except that: the position of the fine powder discharging pipe in the surface modification apparatus of Comparative Example 1 was changed to a central portion of the top face of the fine powder discharging casing 44; and the classified fine powder and ultra-fine powder were discharged from the fine powder discharging pipe at the central portion of the top face of the fine powder discharging casing 44. The classification yield was 54%.

This invention being thus described, it will be obvious that same may be varied in various ways. Such variations are not to be regarded as departure from the spirit and scope of the invention, and all such modifications would be obvious for one skilled in the art intended to be included within the scope of the following claims.

This application claims priority from Japanese Patent Application No. 2003-359876 filed Oct. 20, 2003 and Japanese Patent Application No. 2004-303034 filed Oct. 18, 2004, both of which are hereby incorporated by reference herein.

1. A process for producing a toner containing toner particles, comprising:
a) a kneading step of melting and kneading a composition containing at least a binder resin, a wax, and a colorant to obtain a kneaded product;
b) a cooling step of cooling the kneaded product to obtain a cooled and solidified product;
c) a pulverizing step of finely pulverizing the cooled and solidified product to obtain a finely pulverized product; and
d) a step of simultaneously performing a surface modification step for subjecting particles in the finely pulverized product to surface modification and a classification step for removing fine powder and ultra-fine powder in the resultant finely pulverized product to obtain toner particles, wherein:
the step of simultaneously performing the surface modification step and the classification step to obtain toner particles is performed by using a batch-wise surface modification apparatus;
the surface modification apparatus comprises:
i) a cylindrical casing main body;
ii) a loading portion having a loading pipe for loading the finely pulverized product into the casing main body;
iii) classification means having a classification rotor that rotates in a predetermined direction to continuously remove fine powder and ultra-fine powder each having a predetermined particle diameter or smaller from the finely pulverized product loaded into the casing main body to an outside of the apparatus;
iv) a fine powder discharging portion having a fine powder discharging pipe for discharging the fine powder and the ultra-fine powder removed by the classification means to an outside of the casing main body;
v) surface modification means having a dispersion rotor, which rotates in the same direction as the direction in which the classification rotor rotates, for subjecting particles in the finely pulverized product from which the fine powder and the ultra-fine powder are removed to a surface modification treatment by using a mechanical impact force;
vi) cylindrical guide means for forming a first space and a second space in the casing main body; and
vii) a toner particle discharging portion for discharging toner particles which are subjected to the surface modification treatment by the dispersion rotor to the outside of the casing main body;
the first space is formed between an inner side wall of the casing main body and an outer surface of the cylindrical guide means and comprises a space for introducing the finely pulverized product and surface-modified particles into the classification rotor;
the second space is formed inside the cylindrical guide means and comprises a space for treating the finely pulverized product from which the fine powder and the ultra-fine powder are removed and the surface-modified particles with the dispersion rotor;
in the surface modification apparatus, the finely pulverized product loaded into the casing main body from the loading portion is introduced into the first space, the fine powder and the ultra-fine powder each having a predetermined particle diameter or smaller are removed and continuously discharged to the outside of the apparatus by the classification means while the finely pulverized product from which the fine powder and the ultra-fine powder are removed is moved to the second space and treated with the dispersion rotor to subject the particles in the finely pulverized product to a surface modification treatment, and the finely pulverized product containing the surface-modified particles is circulated in the first space and the second space again, whereby the classification and the surface modification treatment are repeated to obtain surface-modified toner particles in which an amount of each of fine powder and ultra-fine powder each having a predetermined particle diameter or smaller is reduced to a predetermined amount or less;
the loading portion is formed on a side wall of the casing main body and the fine powder discharging portion is formed on a top face of the casing main body; and
when, in a top projection drawing of the surface modification apparatus, a straight line extending from a central position SI of the loading pipe of the loading portion in a direction of loading the finely pulverized product into the first space is denoted by L1 and a straight line extending from a central position O1 of the fine powder discharging pipe of the fine powder discharging portion in a direction of discharging fine powder and ultra-fine powder is denoted by L2, an angle θ formed between the straight line L1 and the straight line L2 is in a range of 210 to 330° with reference to the direction in which the classification rotor rotates.

2. The process for producing a toner according to claim 1, wherein the classification rotor has a tip peripheral speed in a range of 30 to 120 m/sec and the dispersion rotor has a tip peripheral speed in a range of 20 to 150 m/sec.

3. The process for producing a toner according to claim 1, wherein a ratio R1/R2 of the tip peripheral speed R1 of the dispersion rotor to the tip peripheral speed R2 of the classification rotor is in a range of 0.4 to 2.5.

4. The process for producing a toner according to claim 1, wherein:
the finely pulverized product as a raw material has a weight average particle diameter D4 in a range of 3.5 to 9.0 μm and a ratio of particles each having a particle diameter of 4.00 μm or less in a range of 50 to 80% by number;
the toner particles subjected to the surface modification treatment have a weight average particle diameter D4 in a range of 3.5 to 9.0 μm and a ratio of particles each having a particle diameter of 4.00 μm or less in a range of 5 to 40% by number; and
the toner particles subjected to the surface modification treatment have a ratio of toner particles each having a circle-equivalent diameter of 0.6 μm or: more and less than 3 μm in a range of 0 to 15% by number in a number-basis particle diameter distribution of particles each having a circle-equivalent diameter measured with a flow-type particle image measuring device of 0.6 μm or more and 400 μm or less.

5. The process for producing a toner according to claim 1, wherein:
the finely pulverized product as a raw material has a weight average particle diameter D4 in a range of 3.5 to 7.5 μm, a ratio of particles each having a particle diameter of 4.00 μm or less in a range of 55 to 75% by number, and a specific gravity in a range of 1.0 to 1.5 g/cm³.

6. The process for producing a toner according to claim 1, wherein the guide means comprises a cylindrical guide ring.

7. The process for producing a toner according to claim 1, wherein the toner particles subjected to the surface modification treatment have an average circularity in a range of 0.935 to 0.980.

8. The process for producing a toner according to claim 1, wherein the toner particles subjected to the surface modification treatment have an average circularity in a range of 0.940 to 0.980.

9. The process for producing a toner according to claim 1, wherein a ratio R1/R2 of the tip peripheral speed R1 of the dispersion rotor to the tip peripheral speed R2 of the classification rotor is in a range of 0.85 to 2.45 and the toner particles subjected to the surface modification treatment have an average circularity in a range of 0.935 to 0.980.

10. The process for producing a toner according to claim 1, wherein a ratio R1/R2 of the tip peripheral speed R1 of the dispersion rotor to the tip peripheral speed R2 of the classification rotor is in a range of 1.01 to 2.40 and the toner particles subjected to the surface modification treatment have an average circularity in a range of 0.940 to 0.980.

11. The process for producing a toner according to claim 1, wherein when an intersection point of an inner surface of the loading pipe and the inner side wall of the casing main body in the surface modification apparatus is denoted by M3 and a center of the casing main body is denoted by O, an angle X formed between a straight line connecting M3 and O and the inner surface of the loading pipe is in a range of 60 to 90°.
